(19) United States
(12) Patent Application Publication
(10) Pub. No.: US 2024/0319715 A1
(43) Pub. Date: Sep. 26, 2024

(54) SYSTEM AND METHOD FOR DETERMINING THE CHARACTERISTICS OF A MACHINING PROCESS

(71) Applicant: ROLLS-ROYCE plc, London (GB)

(72) Inventors: Fabio N. LEAO, Nottingham (GB); Jonathan D. BUTTERS, Derby (GB); Richard DOUGLAS, Derby (GB); Silvia CISOTTO, Derby (GB); Alexander S. XIDAKIS, Derby (GB); Martyn CUTTELL, Derby (GB)

(73) Assignee: ROLLS-ROYCE plc, London (GB)

(21) Appl. No.: 18/596,199

(22) Filed: Mar. 5, 2024

(30) Foreign Application Priority Data
Mar. 21, 2023 (GB) 2304079.3

(51) Int. Cl. G05B 19/418

(52) U.S. Cl. CPC G05B 19/4183; G05B 19/41835

(57) ABSTRACT

A method for determining one or more characteristics of a hole includes obtaining depth data, tool velocity data, process current data, and a plurality of gates. The method further includes determining a plurality of first, second, and third key points. The plurality of first, second, and third key points together form a plurality of key points. The method further includes obtaining a plurality of rules. Each rule includes one of: a relationship between a respective key point and a value associated with the respective key point; and a relationship between two or more respective key points. The method further includes determining the one or more characteristics of the hole based on the plurality of rules and the plurality of key points.

### CROSS-REFERENCE TO RELATED APPLICATIONS

This specification is based upon and claims the benefit of priority from United Kingdom Patent Application No. GB2304079.3, filed Mar. 21, 2023, the entire contents of which are incorporated herein by reference.

### BACKGROUND

### Technical Field

The present disclosure generally relates to a system and a method for determining characteristics of a machining process.

### Description of the Related Art

Machining processes, such as electrical discharge machining (EDM), are used in manufacturing of various metallic components, including, for example, gas turbine engine components, such as turbine aerofoils. EDM generally uses high energy electrical discharges (i.e., sparks) between an electrode (i.e., a tool) and an electrically conductive workpiece to remove material from the workpiece. EDM fast hole drilling (or high speed EDM drilling) is commonly used by aerospace industry for drilling small holes in gas turbine engine components, e.g., cooling holes in high-pressure turbine blades.

One of the most critical phases of EDM fast hole drilling is when the electrode breaks through the workpiece (or hole breakthrough) as it may result in non-conformances, such as blocked holes, tapered holes, and back wall impingement (BWI). Hole breakthrough is currently controlled by means of changes in process parameters, i.e., depth of the hole, tool velocity, and process current with respect to time. These changes are represented in the form of corresponding plots. These plots are generated using data signals produced by an encoder that is part of a servo system which controls a position of the tool. Depending on a number of non-conformances produced, these plots are later inspected in a software tool for understanding a root cause of the non-conformances.

There are limited software tools currently available to analyse the plots and the current software tools lack the capability to analyse large amount of data. For example, only a few plots may be visualised at a time, which makes the analysis extremely time consuming. Additionally, the current software tools may not allow determination of machining process drifts as well as process stability. Further, the analysis is performed manually, which is also time consuming and dependent on skills of a user. As a result, these plots are analysed on an ad hoc basis and done sporadically when there is a strong need to understand the root cause of the non-conformance. This is because the aforementioned approach is very limited, time consuming, and requires process expertise. Furthermore, certain aspects of the plots may not be visualised together, thereby requiring the analysis to be carried out with minimum number of plots.

Non-conformances, such as BWI and blocked holes, are difficult to detect using the existing inspection methods. This may have a significant impact on the gas turbine engine. Components such as turbine aerofoils are critical to working of the gas turbine engine and are quite sensitive to manufacturing variation. The existing set-up also lacks tools for process control required to improve yield and minimise process variation. Further, the existing set up is such that process engineers only react to non-conformances, instead of preventing them.

### SUMMARY

According to a first aspect, there is provided a method for determining one or more characteristics of a hole machined in at least one workpiece by a machining process. The method includes obtaining depth data including a variation of a depth of the hole with respect to time, tool velocity data including a variation of a tool velocity of a tool performing the machining process with respect to time, process current data including a variation of an average process current generated during the machining process with respect to time, and a plurality of gates. Each of the plurality of gates detects a respective phase in the machining process. Each gate includes a beginning and an end with respect to time. The method further includes determining a plurality of first key points for the depth data, the tool velocity data, and the process current data. Each of the plurality of first key points corresponds to a respective key event in the respective depth data, the respective tool velocity data, or the respective process current data. The method further includes determining a plurality of second key points. Each of the plurality of second key points characterize the beginning or the end of a respective gate from the plurality of gates. The method further includes determining a plurality of third key points. Each of the plurality of third key points is formed by an intersection between a respective gate from the plurality of gates and the respective depth data, the tool velocity data, or the process current data. The plurality of first key points, the plurality of second key points, and the plurality of third key points together form a plurality of key points corresponding to the machining process. The method further includes obtaining a plurality of rules associated with the plurality of key points. Each of the plurality of rules includes one of: a relationship between a respective key point from the plurality of key points and a value associated with the respective key point; and a relationship between two or more respective key points from the plurality of key points. The method further includes determining the one or more characteristics of the hole based on the plurality of rules and the plurality of key points.

The method may allow determination of the plurality of key points (i.e., the plurality of first key points, the plurality of second key points, and the plurality of third key points) for the depth data, the tool velocity data, and the process current data. The method may also utilize the plurality of rules associated with the plurality of key points. The plurality of rules may be designed to establish a correlation between the plurality of key points and the one or more characteristics of the hole (e.g., a blocked hole, a tapered hole, backwall impingement, etc.). Thus, the method may allow accurate determination of the one or more characteristics of the hole after completion of the machining process since the plurality of key points may precisely indicate a condition of the hole machined in the at least one workpiece. This may allow determination of a root-cause of the non-conformance and to implement process changes to contain the problem.

The method may allow automated inspection of the hole based on the plurality of key points and the plurality of rules which would have otherwise been a time-consuming process and dependent on the skills of an operator. Additionally, the present method may improve a reliability of inspection of the hole due to the determination of the plurality of key points that allow for accurate determination of the one or more characteristics of the hole. Subsequently, the at least one workpiece may be automatically sent for rework upon determination of non-conformances.

Alternatively, the method may aid in manual inspection of the hole in a quick and accurate manner as the manual inspection may be performed based on the plurality of key points and the plurality of rules, which help in the determination of the one or more characteristics of the hole, thereby reducing an inspection time and improving an output of the machining process.

The plurality of gates may be programmed within a machining program of the machining process to control the machining process based on the respective phase (e.g., a hole breakthrough phase, a hole completion phase) of the machining process. The plurality of gates may indicate occurrence of the respective phase based on triggering of the respective gate. Each gate is triggered when the gate intersects the respective depth data, the tool velocity data, or the process current data as determined by the third key points.

In some embodiments, the proposed method further includes determining one or more characteristics of the machining process based on the plurality of rules and the plurality of key points. In some embodiments, the one or more characteristics of the machining process include process capability and process stability. Further, the proposed method may allow automated adjustment of the machining process or the machining program (e.g., the plurality of gates) based on the plurality of key points and the plurality of rules which would have otherwise been a time-consuming process and dependent on the skills of the operator. Thus, the present method may also improve a reliability of the machining process.

In some embodiments, at least one rule from the plurality of rules includes that one third key point from the plurality of third key points does not include a null value. In some embodiments, determining the one or more characteristics of the hole further includes determining that the hole is a non-conforming hole if the one third key point includes a null value. Each of the plurality of third key points is formed by intersection of the respective gate and the respective depth data, the tool velocity data, or the process current data. Null value may indicate that the respective third key point does not exist, and the respective gate is not triggered. Thus, the plurality of third key points may provide indication about non-conformance of the hole.

In some embodiments, at least one rule from the plurality of rules includes the relationship between one first key point from the plurality of first key points and one second key point from the plurality of second key points. In some embodiments, determining the one or more characteristics of the hole further includes determining that the hole is a non-confirming hole if the one first key point and the one second key point do not satisfy the at least one rule. Thus, the method may allow determination of the non-conforming hole based on the relationship between the one first key point and the one second key point.

In some embodiments, at least one rule from the plurality of rules includes the relationship between one second key point from the plurality of second key points and one third key point from the plurality of third key points. In some embodiments, determining the one or more characteristics of the hole further includes determining that the hole is a non-confirming hole if the one second key point and the one third key point do not satisfy the at least one rule. Thus, the method may allow determination 20 of the non-conforming hole based on the relationship between the one second key point and the one third key point.

In some embodiments, at least one rule from the plurality of rules includes the relationship between one first key point from the plurality of first key points and the value associated with the one first key point. In some embodiments, determining the one or more characteristics of the hole further includes determining that the hole is a non-confirming hole if the one first key point does not satisfy the at least one rule. Thus, the method may allow determination of the non-conforming hole based on the relationship between the one first key point and the value associated with the one first key point.

In some embodiments, the at least one workpiece includes a plurality of workpieces. In some embodiments, the method further includes selecting one rule from the plurality of rules including the relationship between the two or more respective key points. In some embodiments, the method further includes obtaining a plurality of values of each of the two or more key points corresponding to the plurality of workpieces. In some embodiments, the method further includes applying the one rule to the plurality of values corresponding to the plurality of workpieces. In some embodiments, the method further includes determining a process characteristic of the machining process based on the application of the one rule.

Thus, the method may allow application of the one rule to the plurality of values of each of the two or more key points corresponding to the plurality of workpieces, thereby detecting process drifts (or if the machining process is getting out of control). This may allow the operator to undertake preventive corrective actions in order to avoid occurrence of the non-conformances for future machining of the holes. Prior art solutions lack the capability to perform such an analysis.

In some embodiments, the method further includes changing at least one of the beginning and the end of at least one gate from the plurality of gates based on the one or more characteristics of the hole. The method may allow position of the at least one gate to be reset or reviewed based on the one or more characteristics of the hole. For example, if the at least one gate is not triggered for multiple holes that are found to be non-conforming, it may indicate that the at least one gate is not positioned correctly. The change may be determined based on the plurality of key points. Positions of the gates may be set within the machining program after considering process variations, such as, for example, a casting wall thickness, a tool (or electrode) batch, and a type of a drilling machine.

In some embodiments, the one or more characteristics of the hole include at least one of a conforming hole, a non-conforming hole, a partially blocked hole, a blocked hole, a tapered hole, and a backwall impingement. Thus, the method may allow detection of the non-conformances associated with the hole machined via the machining process.

In some embodiments, the method further includes outputting, via a user interface, the plurality of key points and the one or more characteristics of the hole. The user interface may output the one or more characteristics of the hole to aid in the manual inspection of the hole. Thus, the operator may quickly determine the one or more characteristics of the hole and may undertake the corrective actions accordingly. The user interface may allow the operator to select the at least one workpiece and the hole to be inspected. Further, the user interface may output the plurality of key points determined for the depth data, the tool velocity data, and the process current data, thereby allowing the operator to manually check the signature data. Additionally, the user interface may allow signature data corresponding to multiple holes to be visualized along with the plurality of key points, thereby allowing the operator to compare and accurately identify if the holes are conforming or non-conforming in a quick and reliable manner. The user interface may allow manual uploading of the depth data, the tool velocity data, and the process current data as well. The prior art solutions lack the ability to quickly and accurately analyse signature data corresponding to multiple holes together due to unavailability of the plurality of key points. The user interface may allow determination of the triggering of the plurality of gates in the signature data of multiple holes based on the plurality of key points.

In some embodiments, the machining process is an electrical discharge machining process. Thus, the method may aid in inspection of the hole machined in the at least one workpiece via the electric discharge machining process.

In some embodiments, the at least one workpiece is an aerofoil of a gas turbine engine. In some embodiments, the hole is a cooling hole of the aerofoil of the gas turbine engine. Thus, the method may aid in inspection of the cooling holes of the aerofoil of the gas turbine engine machined via the machining process.

According to a second aspect, there is provided a system for determining one or more characteristics of a hole machined in at least one workpiece by a machining process. The system includes a memory configured to store depth data including a variation of a depth of the hole with respect to time, tool velocity data including a variation of a tool velocity of a tool performing the machining process with respect to time, process current data including a variation of an average process current generated during the machining process with respect to time, and a plurality of gates. Each of the plurality of gates detects a respective phase in the machining process. Each gate includes a beginning and an end with respect to time. The system further includes a processor communicably coupled to the memory and configured to obtain the depth data, the tool velocity data, and the process current data. The processor is further configured to determine a plurality of first key points for the depth data, the tool velocity data, and the process current data. Each of the plurality of first key points corresponds to a respective key event in the respective depth data, the respective tool velocity data, or the respective process current data. The processor is further configured to determine a plurality of second key points. Each of the plurality of second key points characterize the beginning or the end of a respective gate. The processor is further configured to determine a plurality of third key points. Each of the plurality of third key points is formed by an intersection between a respective gate from the plurality of gates and the respective depth data, the tool velocity data, or the process current data. The plurality of first key points, the plurality of second key points, and the plurality of third key points together form a plurality of key points corresponding to the machining process. The processor is further configured to obtain a plurality of rules associated with the plurality of key points from the memory. Each of the plurality of rules includes one of: a relationship between a respective key point from the plurality of key points and a value associated with the respective key point; and a relationship between two or more respective key points from the plurality of key points. The processor is further configured to determine the one or more characteristics of the hole based on the plurality of rules and the plurality of key points.

In some embodiments, at least one of the plurality of rules includes that one third key point from the plurality of third key points does not include a null value. In some embodiments, the processor is further configured to determine that the hole is a non-conforming hole if the one third key point includes a null value.

In some embodiments, at least one rule from the plurality of rules includes the relationship between one first key point from the plurality of first key points and one second key point from the plurality of second key points. In some embodiments, the processor is further configured to determine that the hole is a non-confirming hole if the one first key point and the one second key point do not satisfy the at least one rule.

In some embodiments, at least one rule from the plurality of rules includes the relationship between one second key point from the plurality of second key points and one third key point from the plurality of third key points. In some embodiments, the processor is further configured to determine that the hole is a non-confirming hole if the one second key point and the one third key point do not satisfy the at least one rule.

In some embodiments, at least one rule from the plurality of rules includes the relationship between one first key point from the plurality of first key points and the value associated with the one first key point. In some embodiments, the processor is further configured to determine that the hole is a non-confirming hole if the one first key point does not satisfy the at least one rule.

In some embodiments, the at least one workpiece includes a plurality of workpieces. In some embodiments, the processor is further configured to select one rule from the plurality of rules including the relationship between the two or more respective key points. In some embodiments, the processor is further configured to obtain a plurality of values of each of the two or more key points corresponding to the plurality of workpieces. In some embodiments, the processor is further configured to apply the one rule to the plurality of values corresponding to the plurality of workpieces. In some embodiments, the processor is further configured to determine a process characteristic of the machining process based on the application of the one rule.

In some embodiments, the one or more characteristics include at least one of a conforming hole, a non-conforming hole, a partially blocked hole, a blocked hole, a tapered hole, and a backwall impingement.

In some embodiments, the system further includes a user interface communicably coupled to the processor. In some embodiments, the processor is further configured to output, via the user interface, the plurality of key points and the one or more characteristics of the hole.

In some embodiments, the tool is an electrical discharge machining tool.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a schematic sectional side view of a gas turbine engine, according to an embodiment of the present disclosure;

FIG. 2 is a schematic sectional top view of an aerofoil of a blade of the gas turbine engine, according to an embodiment of the present disclosure;

FIG. 3 is a schematic view of a machining process for machining a hole in at least one workpiece, according to an embodiment of the present disclosure;

FIG. 4 is a schematic block diagram of a system for determining one or more characteristics of the hole machined in the at least one workpiece by the machining process, according to an embodiment of the present disclosure;

FIG. 5 is a graph illustrating variation of a depth of the hole with respect to time, variation of a tool velocity of a tool with respect to time, variation of an average process current with respect to time, and a plurality of key points, according to an embodiment of the present disclosure;

FIG. 6 is a graph illustrating a plurality of values of a first key point corresponding to a plurality of workpieces, and a value of a second key point pre-set in a machining program of the machining process, according to an embodiment of the present disclosure;

FIG. 7A is a graph illustrating a plurality of values representing a difference between magnitudes of two key points corresponding to the plurality of workpieces, according to an embodiment of the present disclosure;

FIG. 7B is a graph illustrating the plurality of values representing the difference between the magnitudes of the two key points corresponding to the plurality of workpieces, according to another embodiment of the present disclosure;

FIG. 7C is a graph illustrating a plurality of values representing a difference between magnitudes of two third key points corresponding to a plurality of workpieces, according to an embodiment of the present disclosure;

FIG. 8 is a schematic view of a criteria tab of a user interface, according to an embodiment of the present disclosure;

FIG. 9 is a schematic view of an upload tab of the user interface, according to an embodiment of the present disclosure;

FIG. 10 is a schematic view of a charts tab of the user interface, according to an embodiment of the present disclosure;

FIG. 11 is a schematic view of the charts tab of the user interface, according to another embodiment of the present disclosure;

FIG. 12 is a flowchart illustrating an electrical discharge machining (EDM) process, according to an embodiment of the present disclosure; and

FIG. 13 is a flowchart illustrating a method for determining the one or more characteristics of the hole machined in the at least one workpiece by the machining process, according to an embodiment of the present disclosure.

### DETAILED DESCRIPTION

Aspects and embodiments of the present disclosure will now be discussed with reference to the accompanying figures. Further aspects and embodiments will be apparent to those skilled in the art.

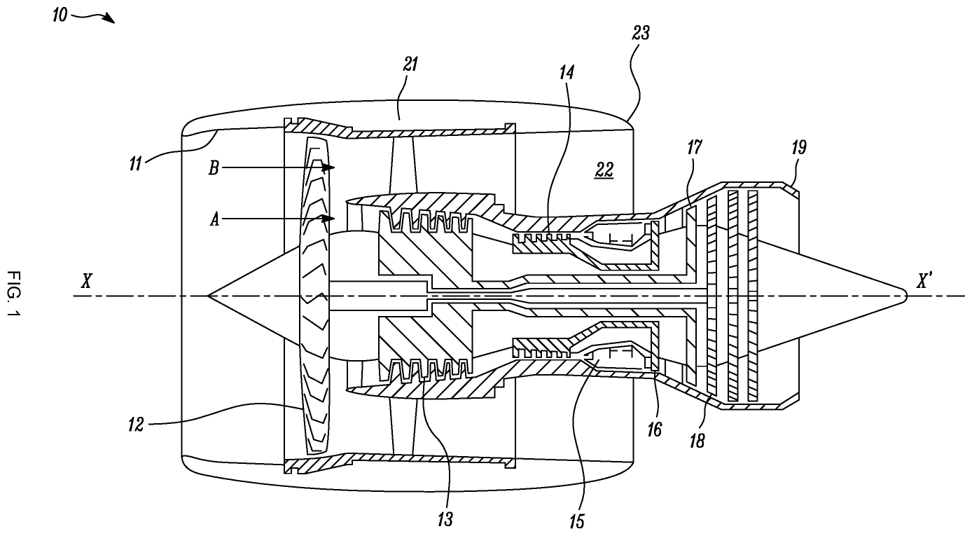

FIG. 1 shows a schematic sectional side view of a gas turbine engine 10 having a principal rotational axis X-X′. The gas turbine engine 10 includes, in axial flow series, an air intake 11, a compressive fan 12 (which may also be referred to as a low pressure compressor), an intermediate pressure compressor 13, a high pressure compressor 14, combustion equipment 15, a high pressure turbine 16, an intermediate pressure turbine 17, a low pressure turbine 18, and a core exhaust nozzle 19. A nacelle 21 generally surrounds the gas turbine engine 10 and defines the air intake 11, a bypass duct 22 and a bypass exhaust nozzle 23.

The gas turbine engine 10 works in a conventional manner so that the air entering the air intake 11 is accelerated by the compressive fan 12 to produce two air flows: a first air flow A into the intermediate pressure compressor 13, and a second air flow B which passes through the bypass duct 22 to provide a propulsive thrust. The intermediate pressure compressor 13 compresses the first air flow A directed into it before delivering that air to the high pressure compressor 14 where further compression takes place.

The compressed air exhausted from the high pressure compressor 14 is directed into the combustion equipment 15 where it is mixed with fuel and the mixture is combusted. The resulting hot combustion products then expand through, and thereby drive the high, intermediate, and low pressure turbines 16, 17, 18 before being exhausted through the core exhaust nozzle 19 to provide additional propulsive thrust. The high, intermediate, and low pressure turbines 16, 17, 18 respectively drive the high and intermediate pressure compressors 14, 13, and the compressive fan 12 by suitable interconnecting shafts.

In some embodiments, the gas turbine engine 10 is used in an aircraft. In some embodiments, the gas turbine engine 10 is an ultra-high bypass ratio engine (UHBPR). In addition, the present invention is equally applicable to aero gas turbine engines, marine gas turbine engines and land-based gas turbine engines.

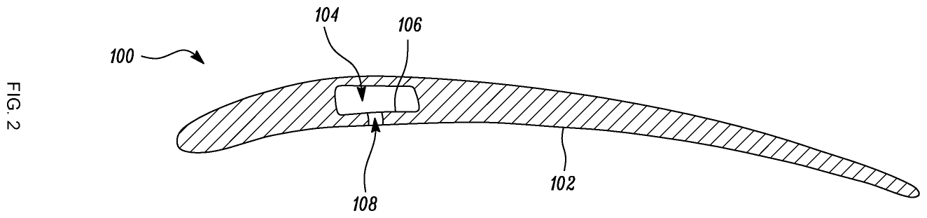

FIG. 2 is a schematic sectional top view of an aerofoil 100 of a blade of the gas turbine engine 10, e.g., a blade of the high, intermediate, or low pressure turbine 16, 17, 18 (shown in FIG. 1). In some embodiments, the aerofoil 100 includes an exterior surface 102, an internal cavity 104, and an interior surface 106 bounding the internal cavity 104. In some embodiments, the aerofoil 100 may be made of a nickel-based super-alloy. In some embodiments, the aerofoil 100 further includes a cooling hole 108 disposed in fluid communication with the internal cavity 104. In some embodiments, the aerofoil 100 may include multiple cooling holes 108, however, only one cooling hole 108 is shown for the purpose of illustration.

In some embodiments, the internal cavity 104 and the cooling hole 108 may provide a portion of a flow path for cooling air. For example, the cooling air flows into the internal cavity 104 of the aerofoil 100, out the cooling hole 108, and over the exterior surface 102 of the aerofoil 100 to provide film cooling to the aerofoil 100. Because the cooling hole 108 forms the portion of the flow path for the cooling air, it is important for the cooling hole 108 to possess characteristics of complete break-through, i.e., extend completely through the interior surface 106.

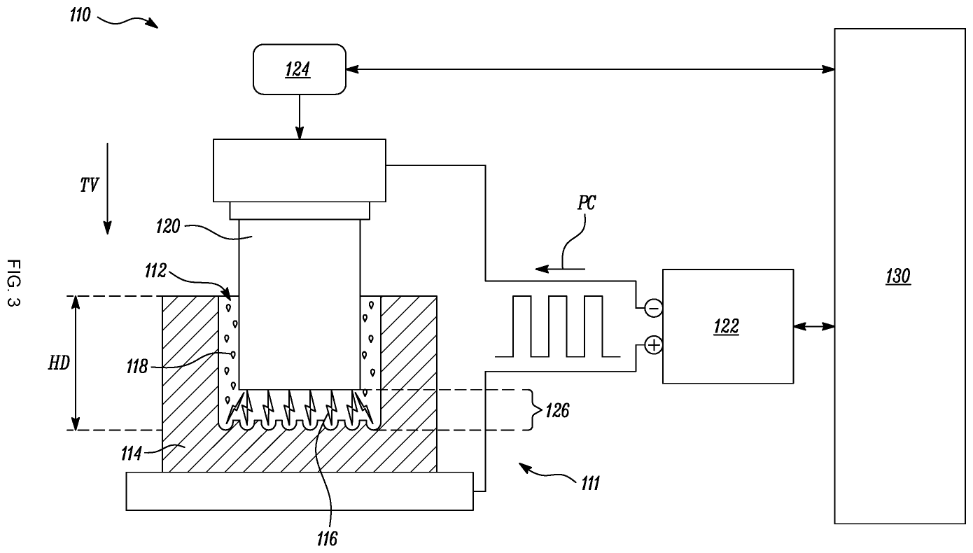

FIG. 3 is a schematic view of a machining process 110 for machining a hole 112 in at least one workpiece 114. In some embodiments, the at least one workpiece 114 is the aerofoil 100 (shown in FIG. 2) of the gas turbine engine 10 (shown in FIG. 1). In some embodiments, the hole 112 is the cooling hole 108 (shown in FIG. 2) of the aerofoil 100 of the gas turbine engine 10.

In some embodiments, the machining process 110 is an electrical discharge machining (EDM) process for machining holes with complex geometries in electrically conductive workpiece materials. Specifically, the machining process 110 is an EDM fast-hole drilling process. In some embodiments, the machining process 110 is carried out using a drilling machine 111. In some embodiments, the machining process 110 may enable removal of the workpiece material by sparks 116 between a tool 120 and the at least one workpiece 114, with associated melting and vaporisation caused by high temperatures.

In some embodiments, the tool 120 may be an electrode made of, e.g., graphite, copper, or brass. In some embodiments, the tool 120 is an electrical discharge machining tool. In some embodiments, the machining process 110 may utilize a single point electrode as the tool 120 for producing one hole at a time. However, the machining process 110 may also utilize multi-point electrodes for producing multiple holes simultaneously.

The at least one workpiece 114 being machined and the tool 120 are generally covered in a dielectric fluid 118 (usually deionised water) and are connected to a power supply 122 or an EDM generator for delivering periodic pulses of energy. In some embodiments, the power supply 122 may include a direct current (DC) power source. Generally, there is no physical contact between the at least one workpiece 114 and the tool 120, and a gap 126 separating the at least one workpiece 114 and the tool 120 is maintained by a fast response servo system 124 that is controlling a movement of the tool 120. In some embodiments, a high-pressure pump (not shown) supplies the dielectric fluid 118 to the gap 126. In some embodiments, the dielectric fluid 118 may be supplied through a bore of the tool 120. Use of the high-pressure pump combined with the fast response servo system 124 and the rotating tool 120 allows rapid machining of the hole 112.

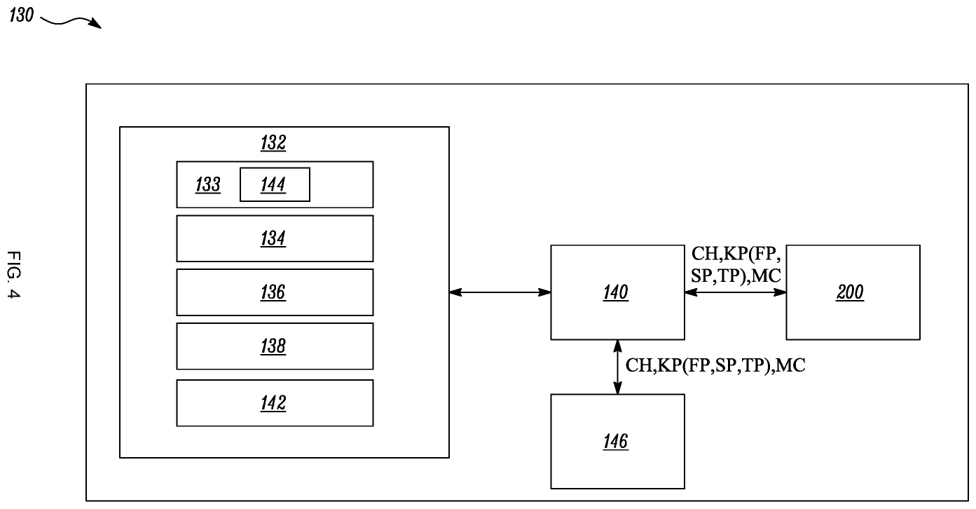

FIG. 4 is a schematic block diagram of a system 130 for determining one or more characteristics CH of the hole 112 machined in the at least one workpiece 114 by the machining process 110 (shown in FIG. 3). Referring to FIGS. 3 and 4, in some embodiments, the system 130 is communicably coupled to the servo system 124 and the power supply 122. In some embodiments, the system 130 includes a memory 132 configured to store a machining program 133 of the machining process 110, depth data 134 including a variation of a depth HD of the hole 112 with respect to time, tool velocity data 136 including a variation of a tool velocity TV of the tool 120 performing the machining process 110 with respect to time, process current data 138 including a variation of an average process current PC generated during the machining process 110 with respect to time, and a plurality of gates 144(1)-144(N) (collectively, gates 144), where N is a positive integer corresponding to a total number of the gates 144.

In some embodiments, the depth HD is defined as a position of the tool 120 that travels to keep the gap 126 between the tool 120 and the at least one workpiece 114 constant. In some embodiments, the depth HD may be defined as a sum of a hole depth of hole 112 and a tool wear of the tool 120. In some embodiments, the tool velocity TV is the velocity by which the tool 120 travels to keep the gap 126 constant. In some embodiments, the average process current PC is defined by an actual average electrical current employed to the machining process 110. In some embodiments, the depth data 134 and the tool velocity data 136 are generated using data signals produced by an encoder that is a part of the servo system 124 which controls the position of the tool 120. In some embodiments, the process current data 138 is generated using data signals produced by a measurement system/signal processor that is connected to the power supply 122 (or the EDM generator).

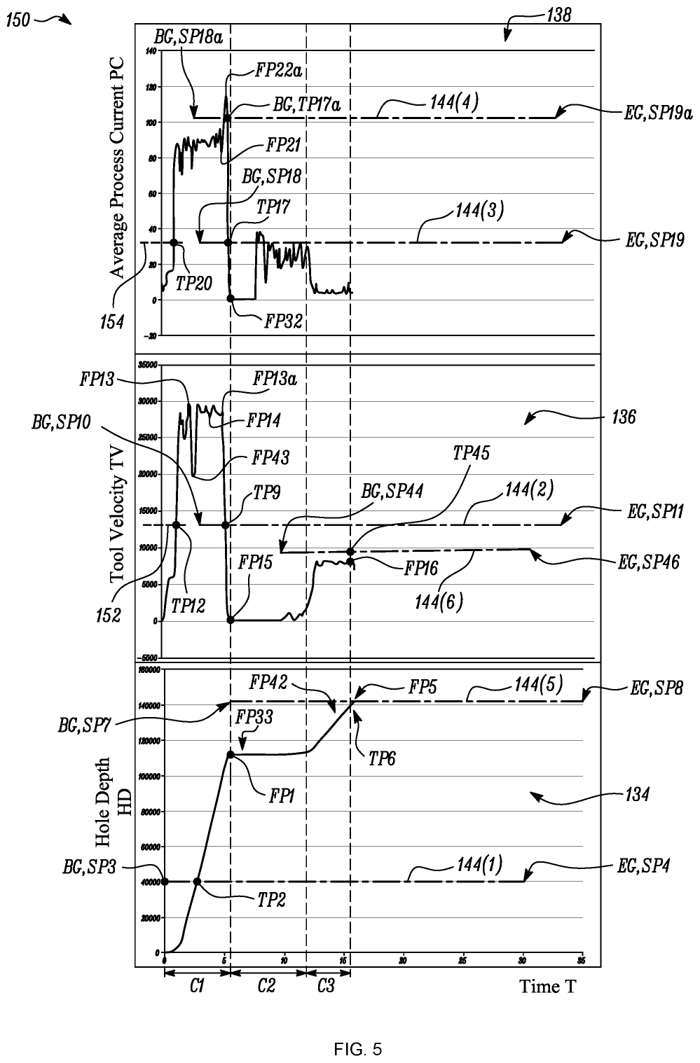

In some embodiments, the depth data 134, the tool velocity data 136, and the process current data 138 may be generated during the machining process 110 as the tool 120 moves to produce the hole 112. For example, the depth data 134 may include a magnitude of the depth HD of the hole 112 achieved at different points in time, the tool velocity data 136 includes a magnitude of the velocity of the tool 120 advancing towards the at least one workpiece 114 at different points in time, and the process current data 138 may include a magnitude of the average process current PC for producing the hole 112 at different points in time. In some embodiments, the plurality of gates 144 may be programmed within the machining program 133. In some embodiments, each of the plurality of gates 144 detects a respective phase C1-C3 (shown in FIG. 5) in the machining process 110.

The system 130 further includes a processor 140 communicably coupled to the memory 132. In some examples, the processor 140 may be embodied in a number of different ways. For example, the processor 140 may be embodied as various processing means, such as one or more of a microprocessor, or other processing elements, a coprocessor, or various other computing or processing devices, including integrated circuits, such as, for example, an ASIC (application specific integrated circuit), an FPGA (field programmable gate array), or the like. In some examples, the processor 140 may be configured to execute instructions stored in the memory 132. In some examples, the memory 132 may be a cache memory, a system memory, or any other memory.

As such, whether configured by hardware, or by a combination of hardware and software, the processor 140 may represent an entity (e.g., physically embodied in a circuitry—in the form of a processing circuitry) capable of performing operations according to some embodiments while configured accordingly. Thus, for example, when the processor 140 is embodied as an ASIC, FPGA, or the like, the processor 140 may have specifically configured hardware for conducting the operations described herein. Alternatively, as another example, when the processor 140 may be embodied as an executor of software instructions, the instructions may specifically configure the processor 140 to perform the operations described herein.

In some examples, the memory 132 may be a main memory, a static memory, or a dynamic memory. The memory 132 may include, but not limited to, computer readable storage media, such as various types of volatile and non-volatile storage media, including, but not limited to, random access memory (RAM), read-only memory (ROM), programmable read-only memory, electrically programmable read-only memory (EPROM), electrically erasable programmable read-only memory (EEPROM), flash memory, magnetic tape or disk, optical media, solid-state memory array, and/or the like.

FIG. 5 is a graph 150 illustrating variation of the depth HD of the hole 112 with respect to time T, variation of the tool velocity TV of the tool 120 with respect to time T, and variation of the average process current PC with respect to time T. Specifically, the graph 150 illustrates a combination of the depth data 134, the tool velocity data 136, the process current data 138, and the plurality of gates 144. The depth data 134, the tool velocity data 136, the process current data 138 are shown in FIG. 5 as respective plots with respect to time T for illustrative purposes only. It should be understood that the depth data 134, the tool velocity data 136, the process current data 138 may also be represented by any other visual or graphical means without limiting the present disclosure.

In the depth data 134, the magnitude of the depth HD of the hole 112 is shown along the vertical axis or ordinate of the graph 150. In the tool velocity data 136, the magnitude of the tool velocity TV of the tool 120 is shown along the vertical axis or ordinate of the graph 150. In the process current data 138, the magnitude of the average process current PC is shown along the vertical axis or ordinate of the graph 150. Further, a magnitude of time T (i.e., drilling time) is shown along the horizontal axis or abscissa of the graph 150.

Referring to FIGS. 4 and 5, in some embodiments, the machining process 110 can be divided into a plurality of phases C1-C3. The phase C1 may represent blind hole drilling, the phase C2 may represent hole breakthrough, the phase C3 may represent hole finishing. In some embodiments, during the phase C1 (i.e., during blind hole drilling), the depth HD increases gradually with respect to time T, while the tool velocity TV and the average process current PC remain more or less constant with respect to time T. However, during the phase C2 (i.e., during hole breakthrough), the depth HD tends to remain constant while the tool velocity TV decreases and the average process current PC fluctuates. During the phase C3 (i.e., during hole finishing), the machining process 110 ends as a tip of the tool 120 travels towards internal cavity 104 of the aerofoil 100 (shown in FIG. 2). Further, the depth HD and the tool velocity TV tend to increase while the average process current PC tends to decrease during the phase C3. The phases C1-C3 are shown in FIG. 5 by way of example only, and numerous other phases may be defined for the machining process 110 based on application requirements.

After completion of the machining process 110, the processor 140 is configured to obtain the depth data 134, the tool velocity data 136, the process current data 138. In some embodiments, the processor 140 is further configured to obtain the plurality of gates 144(1)-(N) (collectively, gates 144). In some embodiments, each of the plurality of gates 144 is indicative of the respective phase C1-C3 of the machining process 110. For example, the gate 144(1) represents that the hole 112 has started to be formed, i.e., the phase C1, and a minimum section thickness has been reached. Similarly, the gate 144(5) represents that the hole breakthrough is fully achieved, i.e., the phase C3, and so on.

In some embodiments, the plurality of gates 144 may be programmed within the machining program 133 to control the machining process 110 based on the respective phase C1-C3. In some embodiments, the plurality of gates 144 may indicate occurrence of the respective phase C1-C3 of the machining process 110 based on triggering of the respective gate 144. For example, the drilling machine 111 may be able to determine if the hole breakthrough is achieved based on triggering of the respective gate 144. Each gate 144 is triggered when the gate 144 intersects the respective depth data 134, the tool velocity data 136, or the process current data 138. Each gate 144 includes a beginning BG and an end EG with respect to time T.

The processor 140 is further configured to determine a plurality of first key points FP(1)-FP(Q) (collectively, first key points FP) for the depth data 134, the tool velocity data 136, and the process current data 138, where Q is a positive integer corresponding to a total number of the first key points FP. Each of the plurality of first key points FP(1)-FP(Q) corresponds to a respective key event in the respective depth data 134, the respective tool velocity data 136, or the respective process current data 138.

The processor 140 is further configured to determine a plurality of second key points SP(1)-SP(R) (collectively, second key points SP), where R is a positive integer corresponding to a total number of the second key points SP. Each of the plurality of second key points SP(1)-SP(R) characterize the beginning BG or the end EG of a respective gate 144. The processor 140 is further configured to determine a plurality of third key points TP(1)-TP(S) (collectively, third key points TP), where S is a positive integer corresponding to a total number of the third key points TP. Each of the plurality of third key points TP(1)-TP(S) formed by intersections between a respective gate 144(1)-144(N) from the plurality of gates 144 and the respective depth data 134, the tool velocity data 136, or the process current data 138. The plurality of first key points FP, the plurality of second key points SP, and the plurality of third key points TP together form a plurality of key points KP corresponding to the machining process 110.

In the illustrated graph 150 of FIG. 5, some of the plurality of first key points FP, some of the plurality of second key points SP, and some of the plurality of third key points TP are shown for the purpose of illustration. Further, the plurality of first key points FP are defined by the Cartesian coordinate system, i.e., FPn (x,y); where n is a positive integer (e.g., n=1, 2, 3, etc.), x is time T, and y is the magnitude of the depth HD, the tool velocity TV, or the average process current PC. Further, the first key points FPix and FPiy denote projections of the first key point FPi (i=1, 2, . . . , n) along the x-axis and y-axis, respectively. Similarly, the plurality of second key points SP and the plurality of third key points TP are also defined by the Cartesian coordinate system.

In some embodiments, the first key point FP1 is the point in the plot of the depth data 134 where the hole 112 starts to breakthrough. Thus, the first key point FP1 may represent a key event in the machining process 110. A magnitude of the first key point FP1y is defined by a length of the hole 112 that has been drilled and an amount (length) of the tool 120 used (or electrode wear) in the machining process 110. The first key point FP1 is the point in time T when the plot of the depth data 134 changes its inclination to nearly a horizontal line. The first key point FP1 tends to be aligned with the first key points FP15 and the first key point FP32, where the tool velocity TV and the average process current PC respectively achieve their minimum values.

At the beginning of hole breakthrough, most of the dielectric fluid 118 that comes from the bore of the tool 120 at a pressure of up to 100 bars is no longer supplied to the gap 126. As a result, the tool velocity TV and the average process current PC reduce dramatically. However, a number of factors may affect the drop in the tool velocity TV and the average process current PC, or the change in the inclination of the plot of depth data 134, which makes it difficult to identify the first key point FP1. In order to solve this problem, data is filtered for “smoothing” of the signature data, followed by application of a derivative method to determine the first key point FP1 robustly.

In some embodiments, the third key point TP2 is the point in the plot of the depth data 134 where the gate 144(1) is triggered. In other words, the third key point TP2 represents intersection between the gate 144(1) and the plot of the depth data 134. The gate 144(1) may represent beginning of the generation of the hole 112 (i.e., the phase C1). In some embodiments, the phase C1 may end upon the hole breakthrough. A magnitude of the third key point TP2y is fixed and may only change if there is a change in the machining program 133.

The gate 144(1) can be used to simultaneously trigger the gate 144(2), the gate 144(3), and the gate 144(4). The gates 144(2), 144(3), 144(4) may be hereinafter referred to as hole breakthrough gates. The gate 144(1) is used to ensure that the hole breakthrough gates are enabled at a correct time. The second key point SP3 and the second key point SP4 are the points on the plot of the depth data 134 where the gate 144(1) begins and ends, respectively. Therefore, the second key point SP3 characterizes the beginning BG of the gate 144(1) and the second key point SP4 characterizes the end EG of the gate 144(1). Positions of the second key points SP3, SP4 are fixed and may only change if there is a change in the machining program 133.

In some embodiments, the first key point FP5 is the point on the plot of the depth data 134 where the machining process 110 finishes. The third key point TP6 is the point where the gate 144(5) is triggered. In other words, the third key point TP6 represents intersection between the gate 144(5) and the plot of the depth data 134. The function of the gate 144(5) is to stop the machining process 110 after the hole breakthrough is fully achieved (i.e., the phase C3). This means that the tool 120 is programmed to travel to a certain distance after the first key point FP1 is reached. A difference between the first key point FP5 and the third key point TP6 is that the end of the machining process 110 is controlled when the third key point TP6 is triggered, whereas the end of machining process 110 will be output by the first key point FP5 in case the gate 144(5) is missed or not programmed, i.e., the end of the machining process 110 is controlled by fixed hole depth established in the machining program 133. Otherwise, the first key point FP5 and the third key point TP6 may have same values when the third key point TP6 (or the gate 144(5)) is triggered.

In some embodiments, the second key point SP7 represents the beginning BG of the gate 144(5). A position of the second key point SP7 is defined by the triggering of the gate 144(2), and/or the gate 144(3), and/or the gate 144(4). The second key point SP8 represents the end EG of the gate 144(5). The third key point TP9 is the point on the plot of the tool velocity data 136 where the gate 144(2) is triggered. In other words, the third key point TP9 represents intersection between the gate 144(2) and the plot of the tool velocity data 136.

The second key point SP10 represents the beginning BG of the gate 144(2). A magnitude of the second key point SP10x may be defined by the triggering of the gate 144(1). A magnitude of the second key point SP10y is fixed and may only change if there is a change in the machining program 133. The second key point SP11 represents the end EG of the gate 144(2). The third key point TP12 is the point defined by intersection of a dotted line 152, i.e., an extension of the gate 144(2), with the plot of the tool velocity data 136. The third key points TP12, TP9 are used to determine a period of time at which the second key point SP10 is located. A magnitude of the third key point TP12y is always equal to a magnitude of the third key point TP9y.

In some embodiments, the first key point FP13 is defined by the highest magnitude of the tool velocity TV above that of the third key points TP9, TP12. The first key point P13a is defined by the highest magnitude of the tool velocity TV between the second key point SP10 and the third key point TP9 and before the magnitude of the tool velocity TV starts dropping. The first key point FP14 is defined by the lowest magnitude of the tool velocity TV between the first key point FP13a and the second key point SP10. The first key point FP15 is defined by the lowest magnitude of the tool velocity TV located below and after the third key point TP9. In normal process conditions, the first key point FP15 may be associated with a beginning of the hole breakthrough, i.e., a magnitude of the first key point FP15x is equal to a magnitude of the first key point FP1x.

A magnitude of the first key points FP13y, FP13ay relative to a magnitude of the first key point FP15y may determine a drop in the magnitude of the tool velocity TV at the hole breakthrough, and as a result, a robustness of the machining process 110 may be determined. In some embodiments, the first key point FP16 is defined by an end of the plot of the tool velocity data 136. A magnitude of the first key point FP16x is equal to a magnitude of the first key point FP5x.

The third key point TP17 and the third key point TP17a are the points on the plot of the process current data 138 where the gate 144(3) and the gate 144(4) are triggered, respectively. In other words, the third key point TP17 represents intersection between the gate 144(3) and the plot of the process current data 138, and the third key point TP17a represents intersection between the gate 144(4) and the plot of the process current data 138. The average process current PC tends to behave differently from the tool velocity TV when the hole breakthrough begins. While a magnitude of the tool velocity TV always drops when the hole breakthrough begins, the average process current PC may increase, depending on factors, such as machining (or gap) voltage, the tool velocity TV, and a tip wear of the tool 120.

The second key point SP18 represents the beginning BG of the gate 144(3) and the second key point SP19 represents the end EG of the gate 144(3). The second key point SP18a represents the beginning BG of the gate 144(4) and the second key point SP19a represents the end EG of the gate 144(4). The third key point TP20 (together with the third key point TP17) may be used to determine a width of the plot of the process current data 138. The third key point TP20 is defined by a point at which a dotted line 154 crosses an ascending line of the average process current PC in the plot of the process current data 138. The dotted line 154 is an extension of the gate 144(3).

In some embodiments, the first key point FP21 is defined by the lowest magnitude of the average process current PC between the second key point SP18 and the first key point FP22a. The first key point FP22a is defined by the highest value of the average process current PC. The first key points FP23-FP31 are not shown in FIG. 5 for the purposes of clarity. The first key point FP32 is defined by the lowest magnitude of the average process current PC below and after the third key point TP17. Magnitudes the first key point FP1x, the first key point FP32x, and the first key point FP15x are the same in normal drilling conditions. The first key points FP33-FP42 are defined by 10 equally time-spaced values of the depth HD between the first key point FP1 and the first key point FP5. The first key points FP34-FP41 are also not shown in FIG. 5 for the purposes of clarity. The first key point FP43 is defined by the lowest value of the tool velocity TV while the magnitude of the first key point FP43x is approximately equal to the magnitude of the third key point TP2x.

In some embodiments, the second key point SP44 represents the beginning BG of the gate 144(6) in the plot of the tool velocity data 136. The third key point TP45 is the point in the plot of the tool velocity data 136 where the gate 144(6) is triggered. In other words, the third key point TP45 represents intersection between the gate 144(6) and the plot of the tool velocity data 136. The function of the gate 144(6) is to stop the machining process 110. The gate 144(6) works in parallel with the gate 144(5). The gate 144(6) is programmed in case the gate 144(5) fails to stop the machining process 110. The second key point SP46 represents the end EG of the gate 144(6) in the plot of the tool velocity data 136.

Changes in the signature data over time, i.e., the depth data 134, the tool velocity data 136, and the process current data 138 are signals that indicate hole breakthrough. These changes are captured by the gates 144. After the machining process 110 is initiated and the depth HD in the plot of the depth data 134 crosses the gate 144(1) (i.e., a depth gate which produces the third key point TP2), the gates 144(2) (i.e., a velocity gate), 144(3), and 144 (4) (i.e., a process current gate) are simultaneously activated.

As hole breakthrough starts, the tool velocity TV drops and the average process current PC increases. The gate 144(5) (i.e., an EDM Off gate which produces the third key point TP6) is triggered when either the tool velocity TV reaches the gate 144(2) (or the velocity gate which produces the third key point TP9), or the average process current PC reaches either the gate 144(3) (or the process current gate which produces the third key point TP17) or the gate 144(4) (which produces the third key point TP17a). The machining process 110 ends when the depth HD in the plot of the depth data 134 reaches the gate 144(5) (or the EDM Off gate), which produces the third key point TP6. The machining process 110 may also end if the tool velocity TV reaches the gate 144 (6), which produces the third key point TP45.

It should be understood that there are numerous (and nearly unlimited) ways to program, to set, to position, or to create the gates 144. It is only the most common approach that is depicted in FIG. 5 for the purpose of disclosing the principles of this invention, and therefore, should not be construed as being limited in any way. It should also be understood that other key points KP may also exist for the depth data 134, the tool velocity data 136, and the process current data 138. However, only some of the plurality of key points KP are shown in FIG. 5 for the purpose of illustration, and should not be construed as being limiting in any way.

The processor 140 is further configured to obtain a plurality of rules 142(1)-142(M) (collectively, rules 142) associated with the plurality of key points KP from the memory 132, where M is a positive integer corresponding to a total number of the rules 142. Each of the plurality of rules 142 includes one of: a relationship between a respective key point KP (i.e., the first key point FP, the second key point SP, or the third key point TP) from the plurality of key points KP and a value associated with the respective key point KP; and a relationship between two or more respective key points KP (i.e., the first key point FP, the second key point SP, or the third key point TP) from the plurality of key points KP.

For example, the plurality of rules 142 may include the relationship between the first key point FP and the value of the first key point FP. Similarly, the plurality of rules 142 may also include the relationship between the second key point SP and the value of the second key point SP, or the relationship between the third key point TP and the value of the third key point TP.

Further, the plurality of rules 142 may also include the relationship between the two or more key points KP. For example, the plurality of rules 142 may include the relationship between the first key point FP and the second key point SP. In some examples, the plurality of rules 142 may also include the relationship between two or more first key points FP. It should be understood that the plurality of rules 142 may include the relationship between the first key points FP, the second key points SP, and the third key points TP in any combination.

The processor 140 is further configured to determine the one or more characteristics CH of the hole 112 based on the plurality of rules 142 and the plurality of key points KP. In some embodiments, the plurality of rules 142(1)-142(M) are designed to establish a condition of the hole 112. Specifically, in some embodiments, the plurality of rules 142 may associate the status of the key points KP and the plurality of gates 144 with the one or more characteristics CH of the hole 112.

In some embodiments, the one or more characteristics CH include at least one of a conforming hole, a non-conforming hole, a partially blocked hole, a blocked hole, a tapered hole, and a backwall impingement (BWI). In some embodiments, the partially blocked hole, the blocked hole, the tapered hole, and the BWI may represent the non-confirming hole. In some embodiments, the processor 140 is further configured to store the one or more characteristics CH of the hole 112 of the at least one workpiece 114 in a memory 146. In some embodiments, the memory 146 may be similar to the memory 132.

Table 1 summarizes the plurality of rules 142(1)-142(16) along with the corresponding characteristic CH of the hole 112. It should be understood that other rules may also exist for the plurality of key points KP, however, the plurality of rules 142(1)-142(16) are described below for descriptive purposes.

TABLE 1

| | | | | | | | Characteristic |
|---|---|---|---|---|---|---|---|
| Rule | If | AND | AND | AND | AND | AND | CH |
| 142(1) | FP5y ≈ | SP7y > | | | | | Partially |
| | FP1y | 0 | | | | | Blocked |
| | | | | | | | Hole |
| 142(2) | FP5Y < | SP8x > | SP7y > | | | | Partially |
| | SP7Y | FP5x > | 0 | | | | Blocked |
| | | SP7x | | | | | Hole |
| 142(3) | SP5Y < | SP8x > | SP7y > | TP9y == | SP10x > | | Partially |
| | SP7Y | FP5x > | 0 | “—” | FP16x > | | Blocked |
| | | SP7x | | | SP11x | | Hole |
| 142(4) | TP2x == | SP4x > | | | | | BWI |
| | “—” | 0 | | | | | |
| 142(5) | TP9x == | SP11x > | TP17y == | SP18y > | FP15x != | FP5y > | BWI |
| | “—” | 0 | “—” | 0 | FP16x | FP5y | |
| | | | | | | (c) | |
| 142(6) | TP9x == | SP11x > | TP17y == | SP18y > | FP15x == | | Partially |
| | “—” | 0 | “—” | 0 | FP16x | | Blocked |
| | | | | | | | Hole |
| 142(7) | TP17y == | SP19x > | TP9x == | SP11y == | | | BWI |
| | “—” | 0 | “—” | “—” | | | |
| 142(8) | TP17y == | SP19x > | TP9x > | | | | Unlikely |
| | “—” | 0 | 0 | | | | |
| 142(9) | TP9x == | SP11x > | TP17y == | SP18y == | | | BWI |
| | “—” | 0 | “—” | “—” | | | |
| 142(10) | FP5x < | TP9y < | | | | | BWI |
| | SP7x | SP10y | | | | | |
| 142(11) | FP5x > | TP9y < | TP6y == | | | | BWI |
| | SP7x | SP10y | “—” | | | | |
| 142(12) | FP5x > | TP9y < | TP6y == | | | | BWI |
| | SP8x | SP10y | “—” | | | | |
| 142(13) | TP9x == | SP11x > | TP17x > | | | | Unlikely |
| | “—” | 0 | 0 | | | | |
| 142(14) | TP9x != | TP2x != | FP5x != | FP5\hat{ }x != | FP5y < | | Blocked |
| | “—” | “—” | “—” | “—” | 0.8*FP5\hat{ }y | | Hole |
| 142(15) | TP2\hat{ }x != | TP9x != | (TP9\hat{ }x − | TP2x < | | | Blocked |
| | “—” | “—” | TP2\hat{ }x) > | 1.5*TP2\hat{ }x | | | Hole |
| | | | 2*(TP9x − | | | | |
| | | | TP2x) | | | | |
| 142(16) | FP5x != | FP1x != | FP5y < | | | | Blocked |
| | “—” | “—” | 0.8*FP1y | | | | Hole |

As shown in Table 1, the rules 142(4), 142(5), 142(7), 142(9), 142(10), 142(11), 142(12) may detect if the hole 112 is produced with a backwall impingement (BWI), the rules 142(1), 142(2), 142(3), 142(6) may detect partially blocked holes, and the rules 142(14), 142(15), 142(16) may detect blocked holes. Other rules 142 may also be established for determining the one or more characteristics CH of the hole 112. Some of these rules 142 are briefly explained as follows.

According to the rule 142(1), the hole 112 is partially blocked if a magnitude of the first key point FP5y (i.e., the key point KP defining the end of the machining process 110) is similar to a magnitude of the first key point FP1y (i.e., the key point KP at which the hole 112 starts to breakthrough). The hole 112 is partially blocked because the machining process 110 stopped in the phase C2 (i.e., hole breakthrough) without proceeding to the phase C3 (i.e., hole finishing). This may indicate that the machining process 110 did not complete the phases C2, C3.

In some embodiments, at least one rule 142 from the plurality of rules 142 includes that one third key point TP from the plurality of third key points TP does not include a null value. In some embodiments, the processor 140 is further configured to determine that the hole 112 is non-conforming if the one third key point TP includes a null value. In the above example, if the magnitude of the first key point FP5y is similar to a magnitude of the first key point FP1y, then the gate 144(5) is not triggered or missed. Consequently, the third key point TP6 may not exist or includes a null value. Thus, based on the one rule 142 from the plurality of rules 142, the processor 140 is further configured to determine that the hole 112 is non-conforming (i.e., a partially blocked hole) if the third key point TP6 includes the null value. In another example, referring to the rule 142(4), the hole 112 is produced with BWI if the third key point TP2 includes a null value (i.e., TP2x==“−”).

In some embodiments, at least one rule 142 from the plurality of rules 142 includes the relationship between one second key point SP from the plurality of second key points SP and one third key point TP from the plurality of third key points TP. In some embodiments, the processor 140 is further configured to determine that the hole 112 is a non-confirming hole if the one second key point SP and the one third key point TP do not satisfy the at least one rule 142. In some embodiments, each third key point TP lies between the beginning BG and the end EG of a respective gate 144 since each third key point TP is formed by intersection between the respective gate 144 and the respective depth data 134, the tool velocity data 136, or the process current data 138. Thus, the at least one rule 142 may be indicative of the one or more characteristics CH of the hole 112. For example, if a magnitude of the one second key point SP is similar to a magnitude of the one third key point TP, the hole 112 may be very close to missing the respective gate 144.

In some embodiments, at least one rule 142 from the plurality of rules 142 includes the relationship between one first key point FP from the plurality of first key points FP and the value associated with the one first key point FP. In some embodiments, the processor 140 is further configured to determine that the hole 112 is a non-confirming hole if the one first key point FP does not satisfy the at least one rule 142. For example, if the first key point FP1 does not exist, the hole 112 may be non-conforming since the hole 112 may have missed hole breakthrough. Similarly, the processor 140 is further configured to determine the one or more characteristics CH of the hole 112 based on the relationship between one second key point SP and the value associated with the one second key point SP or the relationship between one third key point TP and the value associated with the one third key point TP.

A condition for the hole 112 to be fully blocked is included in the rule 142(14), i.e., FP5y<0.8*FP5\hat{ }y. This rule means that an end of a drilling depth (represented by the first key point FP5y) is smaller than 80% of an end of the drilling depth of a master signature data (i.e., a signature data corresponding to a conforming hole) used as baseline data. However, other conditions may also need to be observed. The first key point FP5 and the third key points TP2, TP9 must exist in order to avoid triggering of the other rules 142 associated with BWI.

One of the main causes of blocked holes is premature triggering of the gate 144(2), which is captured by the rule 142(15). The primary condition for triggering of the rule 142(15) is that (TP9\hat{ }x−TP2\hat{ }x)>2*(TP9x−TP2x). The premature triggering of the gate 144(2) occurs if the difference between the time T at which the gate 144(2) and the gate 144(1) are triggered (i.e., TP9x−TP2x) in the master signature data is greater than twice the difference between the time T at which the same gates 144(2), 144(1) are triggered in the signature data being analysed. However, other conditions may need to be observed, i.e., the time T at which the gate 144(1) is triggered in the signature data being analysed needs to be 1.5 times smaller than the time T at which the gate 144(1) is triggered in the master signature data. Furthermore, the third key points TP2, TP9 must exist.

In some embodiments, a difference between a value of the third key point TP9x and a value of the third key point TP2x of the signature data being analysed is enough to indicate blocked hole if this difference is much smaller than the difference between the values of the same third key points TP9x, TP2x corresponding to the signature data sample associated with conforming holes.

In some embodiments, the processor 140 may also employ other techniques for determining the one or more characteristics CH of the hole 112. For example, the processor 140 may be further configured to employ heuristics and machine learning/artificial intelligence techniques for determining the one or more characteristics CH of the hole 112.

In some embodiments, at least one rule 142 from the plurality of rules 142 includes the relationship between one first key point FP from the plurality of first key points FP and one second key point SP from the plurality of second key points SP. In some embodiments, the processor 140 is further configured to determine that the hole 112 is a non-confirming hole if the one first key point FP and the one second key point SP do not satisfy the at least one rule 142.

For example, a magnitude of the first key point FP1y may need to be much greater than a magnitude of the second key point SP3y to ensure that the gate 144(1) (i.e., the depth gate) is triggered, which enables the triggering of all the other gates 144. If the magnitude of the first key point FP1y is smaller than the magnitude of the second key point SP3y, then the gate 144(1) (or the depth gate) is missed, and therefore, the third key point TP2 is not produced. In other words, a difference between the magnitudes of the first key point FP1y and the second key point SP3y should be greater than 0 for the hole 112 to be conforming. Also, according to the rule 142(4) of Table 1, if the third key point TP2 does not exist (i.e., TP2x==“−”) and a magnitude of the second key point SP4x>0 (which indicates that the gate 144(1) has been programmed), then the gate 144(1) (or the depth gate) is not triggered, resulting in a hole that is likely to be produced with BWI.

In some embodiments, if the hole 112 is determined to be a non-conforming hole, the at least one workpiece 114 may need to be reworked. Alternatively, in some embodiments, at least one of the beginning BG and the end EG of at least one gate 144 from the plurality of gates 144 may be changed based on the one or more characteristics CH of the hole 112. For example, the at least one of the beginning BG and the end EG of the at least one gate 144 may be reprogrammed in the machining program 133 to accommodate for any process variations.

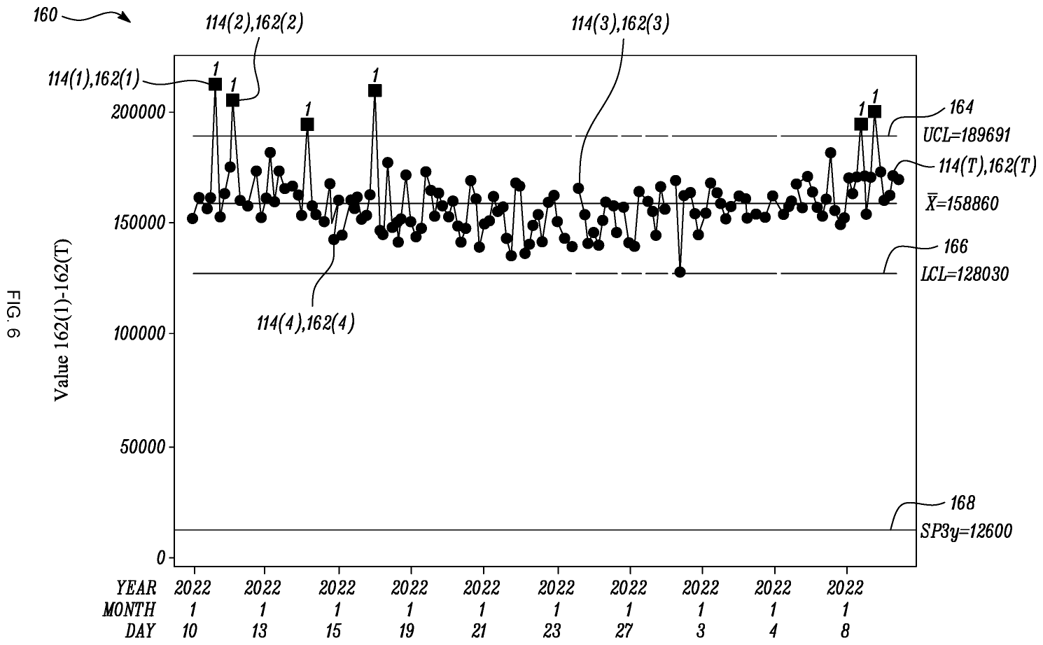

FIG. 6 is a graph 160 illustrating a plurality of values 162(1)-162(T) (collectively, values 162) of the first key point FP1y corresponding to a hole of a plurality of workpieces 114(1)-114(T) (collectively, workpieces 114) and a value 168 of the second key point SP3y corresponding to the gate 144 (1) that was pre-set within the machining program 133 (shown in FIG. 4). The plurality of values 162(1)-162(T) and the value 168 are shown along the vertical axis or ordinate of the graph 160 and a timestamp (i.e., a day, a month, and a year of machining the corresponding workpiece 114) is shown along the horizontal axis or abscissa of the graph 160.

Referring to FIGS. 3-6, in some embodiments, the at least one workpiece 114 includes the plurality of workpieces 114(1)-114(T). In some embodiments, the processor 140 is further configured to select one rule 142 from the plurality of rules 142 including the relationship between the two or more respective key points KP. In the illustrated embodiment of FIG. 6, the two or more respective key points KP include the first key point FP1y and the second key point SP3y. Further, the one rule 142 includes the relationship between the first key point FP1y and the second key point SP3y. Specifically, the one rule 142 may include that the difference between the first key point FP1y and the second key point SP3y is greater than 0, which may indicate production of conforming holes.

In some embodiments, the processor 140 is further configured to obtain the plurality of values 162(1)-162(T) of each of the two or more key points KP (i.e., the first key point FP1y and the second key point SP3y) corresponding to the plurality of workpieces 114(1)-114(T). In the illustrated embodiment of FIG. 6, each of the plurality of values 162(1)-162(T) may represent a magnitude of the depth HD in the hole depth data 134 corresponding to the first key point FP1 for the plurality of workpieces 114(1)-114(T) machined through the same machining process 110. In some embodiments, the value 168 of the second key point SP3y (i.e., the beginning BG of the gate 144(1)) may be fixed within the machining program 133 of the machining process 110. Thus, the value 168 of the second key point SP3y may be same for the plurality of workpieces 114(1)-114(T).

In some embodiments, the processor 140 is further configured to apply the one rule 142 to the plurality of values 162(1)-162(T), 168 corresponding to the plurality of workpieces 114(1)-114(T). In the illustrated embodiment of FIG. 6, the processor 140 may apply the one rule 142 that the difference between each of the plurality of values 162(1)-162(T) and the value 168 should be greater than 0. As shown in FIG. 6, each of the plurality of values 162(1)-162(T) of the first key point FP1y is much greater than the value 168 of the second key point SP3y for the plurality of workpieces 114(1)-114(T). This means that the gate 144(1) (i.e., the depth gate) is triggered, which enables the triggering of all the other gates 144.

In some embodiments, the processor 140 is further configured to determine a process characteristic MC of the machining process 110 based on the application of the one rule 142. In some embodiments, the process characteristic MC of the machining process 110 may include a conforming process or a non-conforming process. Application of the one rule 142 for the plurality of workpieces 114(1)-114(T) may enable testing of the machining process 110 for any process drifts and/or variations, and corrective actions may be implemented subsequently prior to future machining of workpieces. Such an analysis may be referred to as a statistical analysis or statistical process control.

In some embodiments, through the statistical process control, the process characteristic MC of the machining process 110 may be determined based on the plurality of rules 142 and the plurality of key points KP. In some embodiments, the process characteristic MC of the machining process 110 include process capability and process stability. It should be understood that the statistical analysis (or the statistical process control) as shown in FIG. 6 is exemplary and any of the plurality of key points KP may be selected for performing the statistical analysis.

In some embodiments, the processor 140 is further configured to obtain at least one of an upper control limit (UCL) 164 and a lower control limit (LCL) 166 for each of the two or more respective key points KP. In the illustrated embodiment of FIG. 6, the processor 140 is further configured to obtain the UCL 164 and the LCL 166 for the first key point SP3y. In some embodiments, the UCL 164 and the LCL 166 may be statistical parameters calculated based on the plurality of values 162(1)-162(T). For example, a value of the UCL 164 and the LCL 166 may be equal to a multiple of a standard deviation of the plurality of values 162(1)-162(T). Specifically, in some examples, the value of the UCL 164 and the LCL 166 may be three times the standard deviation of the plurality of values 162(1)-162(T).

In some embodiments, the processor 140 is further configured to compare the plurality of the values 162(1)-162(T) of the first key point FP1y with at least one of the UCL 164 and the LCL 166. In some embodiments, the processor 140 is further configured to determine the process characteristic MC further based on the comparison of the plurality of values 162(1)-162(T) of the first key point FP1y with the at least one of the UCL 164 and the LCL 166. In the illustrated embodiment of FIG. 6, the values 162(1), 162(2) are above the UCL 164 while the values 162(3), 162(4) are below the UCL 164. This may indicate that the machining process 110 may be out of control and changes may be required to the machining program 133. On the other hand, the machining process 110 is not necessarily producing non-conforming holes, as the plurality of values 162(1)-162(T) of the first key point FP1y is much greater than the value 168 of the second key point SP3y as shown in FIG. 6.

It should be understood that similar analysis may be performed for any of the plurality of key points KP. Further, it should be understood that other statistical parameters may also be utilized for determining the process characteristic MC, e.g., histograms, bar charts, correlation and regression, etc. Thus, values corresponding to any of the plurality of key points KP for the plurality of workpieces 114 may be analysed for determining a precision of the machining process 110.

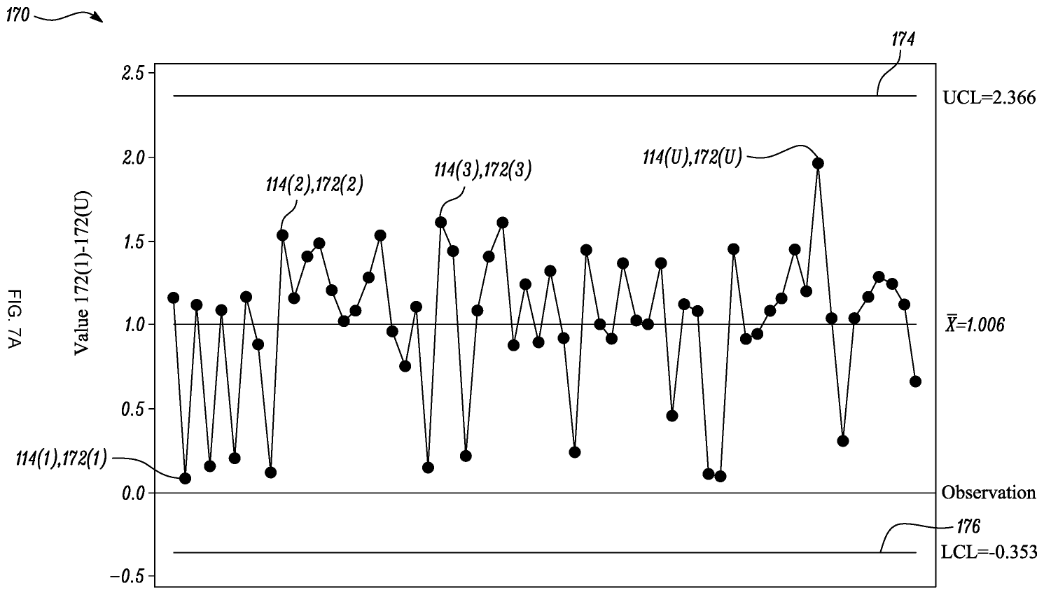

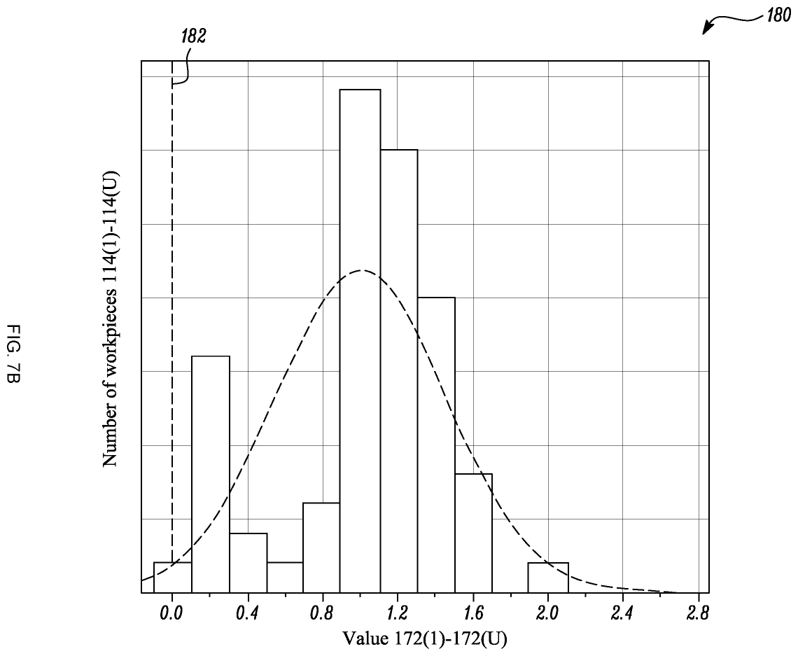

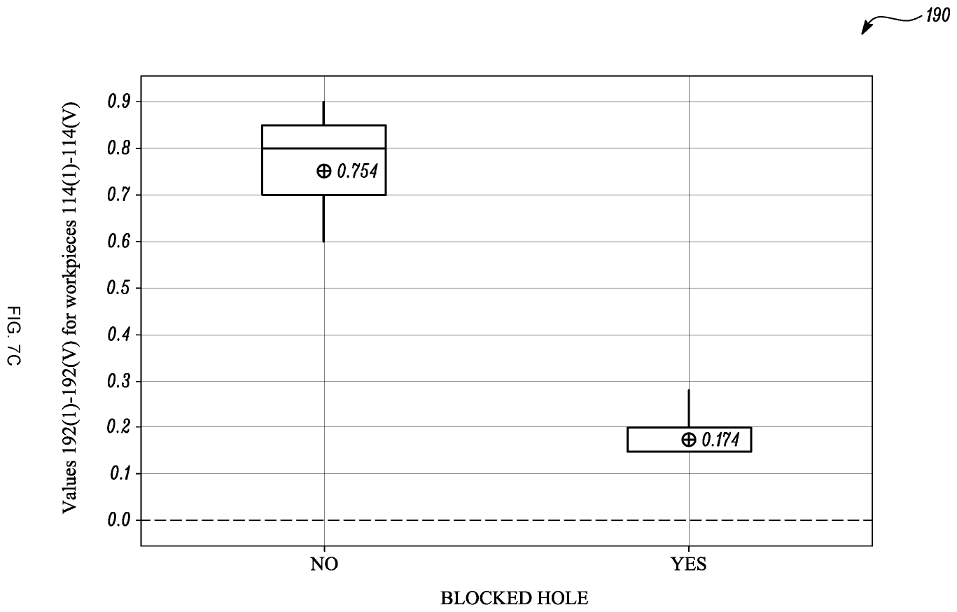

A similar approach may be used to analyse other key points, such as the third key point TP9, which is associated with triggering of the gate 144(2) (or the breakthrough gate). The hole 112 may be produced with BWI in case the gate 144(2) is not triggered. Further, the third key point TP9 does not exist if the gate 144(2) is not triggered. A pragmatic way to analyse this situation is through differences between a magnitude of the third key point TP9x and a magnitude of the second key point SP10x as shown in FIG. 7.

FIG. 7A is a graph 170 illustrating a plurality of values 172(1)-172(U) representing a difference between the magnitudes of the third key point TP9x and the magnitudes of the second key point SP10x corresponding to a plurality of workpieces 114(1)-114(U), where U is a positive integer corresponding to a total number of the workpieces 114. The plurality of values 172(1)-172(U) are shown along the vertical axis or ordinate of the graph 170. Referring to FIGS. 3-5 and 7A, if the magnitude of the third key point TP9x is smaller than the magnitude of the second key point SP10x, then the gate 144(2) is not triggered, which may result in the hole 112 being produced with BWI. In some embodiments, the machining process 110 may be in danger of generating non-conformances if the difference between the magnitude of the third key point TP9x and the magnitude of the second key point SP10x is close to zero.

In the illustrated graph 170, the plurality of workpieces 114 include 62 workpieces. The graph 170 indicates that although the machining process 110 is stable, there are 9 out of 62 workpieces 114 where the plurality of values 172(1)-172(U) are close to zero or close to a lower control limit (LCL) 176. Thus, the gate 144(2) may have been missed for these workpieces resulting in non-conforming holes. Further, the graph 170 indicates that the plurality of values 172(1)-172(U) do not exceed an upper control limit (UCL) 174. Therefore, such an analysis may be used to identify the process drifts and/or variations. In some embodiments, the LCL 176 and the UCL 174 may be determined based on a standard deviation of the plurality of values 172(1)-172(U).

FIG. 7B is a graph 180 illustrating the plurality of values 172(1)-172(U) representing the difference between the magnitudes of the third key point TP9x and the magnitudes of the second key point SP10x corresponding to the plurality of workpieces 114(1)-114(U) (or holes of the workpieces 114), according to another embodiment of the present disclosure. The plurality of values 172(1)-172(U) are shown along the horizontal axis or abscissa of the graph 180 and a frequency of the workpieces 114(1)-114(U) corresponding to the plurality of values 172(1)-172(U) is shown along the vertical axis or ordinate of the graph 180.

Referring to FIGS. 3-5 and 7B, in some embodiments, the graph 180 may represent the same data as shown in FIG. 7A in a different form of graph (a histogram). In some embodiments, the graph 180 may allow a statistical process capability analysis of the same data (difference between the magnitudes of the third key point TP9x and the magnitudes of the second key point SP10x) and may even predict an expected level of non-conformances, in case actions to improve the machining process 110 are not taken. For example, the graph 180 may indicate the total number of non-conforming holes that may be produced. This may be indicated by the total number of the workpieces 114(1)-114(U) for which the plurality of values 172(1)-172(U) are less than or equal to 0 (or a threshold value 182). In the illustrated example of FIG. 7B, some of the plurality of values 172(1)-172(U) are equal to 0. This may indicate that the machining process 110 may be producing non-conforming holes.

FIG. 7C is a graph 190 illustrating a plurality of values 192(1)-192(V) representing a difference between the magnitudes of the third key point TP9x and the magnitudes of the third key point TP2x corresponding to a plurality of workpieces 114(1)-114(V) (or holes of the workpieces 114), where V is a positive integer corresponding to a total number of the workpieces 114. The plurality of values 192(1)-192(V) are shown along the vertical axis or ordinate of the graph 190 and blocked holes are indicated along the horizontal axis or abscissa of the graph 190.

Specifically, the graph 190 shows boxplots of the plurality of values 192(1)-192(V). If the plurality of values 192(1)-192(V) are close to zero, this means that the gate 144 (2) is triggered too soon, resulting in blocked holes. In the example shown in FIG. 7C, blocked holes presented the values 192(1)-192(V) that range from 0.15 to 0.25 with an average of 0.174, whereas the values 192(1)-192(V) corresponding to conforming holes have a much higher range of 0.6 to 0.9 with an average of 0.754.

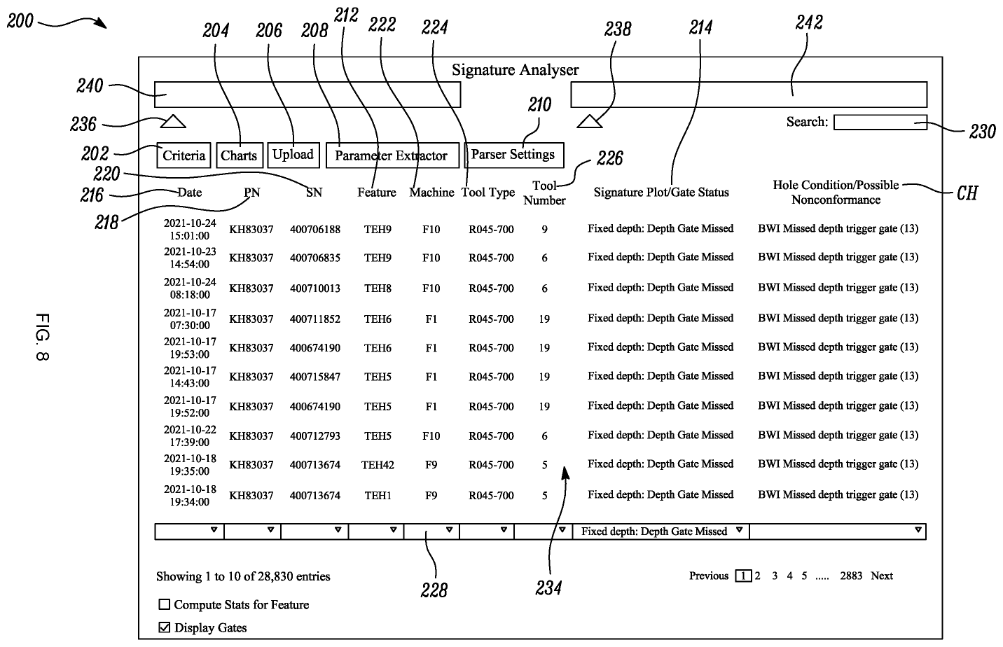

FIG. 8 is a schematic view of a user interface 200. Referring to FIGS. 4-5 and 8, in some embodiments, the system 130 further includes the user interface 200 communicably coupled to the processor 140. In some embodiments, the processor 140 is further configured to output, via the user interface 200, the one or more characteristics CH of the hole 112 (shown in FIG. 3).

In some embodiments, the user interface 200 includes various tabs, a criteria tab 202, a charts tab 204, an upload tab 206, a parameter extractor tab 208, and a parser settings tab 210. Specifically, FIG. 8 illustrates the criteria tab 202 of the user interface 200. The criteria tab 202 is used to view and select features 212 of interest (e.g., a specific hole), associated signature data/gate status 214, and the one or more characteristics CH corresponding to the features 212 (or the hole 112). If the depth gate (i.e., the gate 144(1)) is missed or not triggered, the hole 112 may be produced with BWI. Thus, the one or more characteristics CH for each hole 112 may be shown against the signature data/gate status 214. In some embodiments, an operator may scan a serial number of the at least one workpiece 114 so that the signature data/gate status 214 and the one or more hole characteristics CH are displayed by the user interface 200.

The criteria tab 202 also shows a date 216 when the feature 212 was produced, a part number (PN) 218, a workpiece serial number (SN) 220, a machine identification number 222, a tool type 224, and a tool number 226 used to produce the feature 212. This data is displayed in a section 234 of the criteria tab 202. It is possible to filter the data by every factor of the criteria tab 202 (i.e., the date 216, the PN 218, the SN 220, the feature 212, machine identification number 222, the tool type 224, the tool number 226, the signature data/gate status 214 and the one or more characteristics CH) using a filter 228. Data analysis by the SN 220 of the at least one workpiece 114 is of particular interest and may be performed by inserting the SN 220 in a search box 230. The SN 220 of the at least one workpiece 114 may be inserted either by typing or by scanning the SN 220 directly from the at least one workpiece 114 to be inspected, such that an operator may check the features 212 that are conforming and non-conforming.

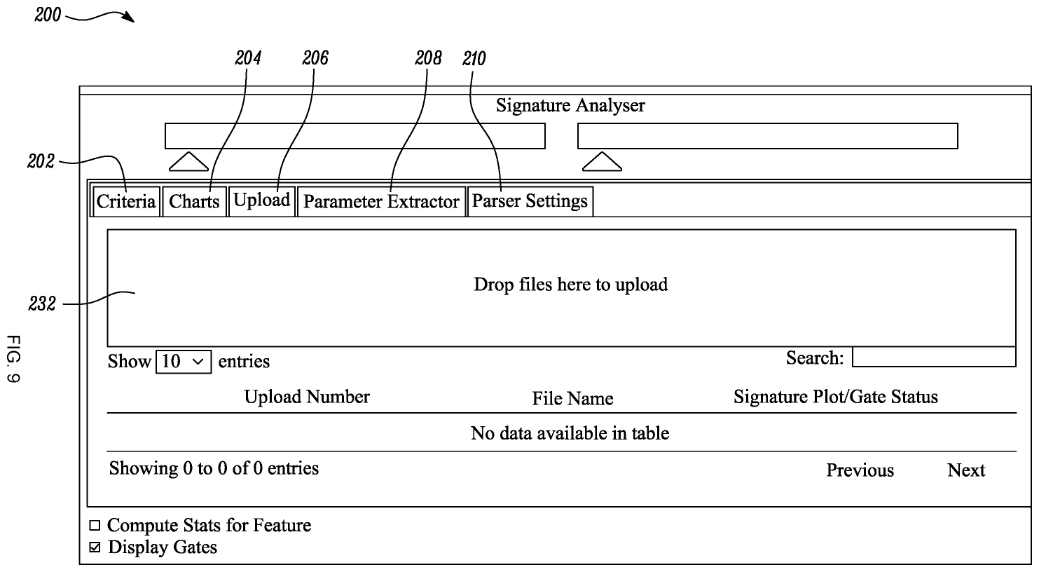

FIG. 9 is a schematic view of the upload tab 206 of the user interface 200. In some embodiments, the upload tab 206 may allow the signature data (i.e., the depth data 134, the tool velocity data 136, and the process current data 138 shown in FIG. 5) to be uploaded manually. This is achieved by dropping the signature data into the search box 232. Signature plots (i.e., plots corresponding to the depth data 134, the tool velocity data 136, and the process current data 138 shown in FIG. 5) are generated after selecting the feature 212 (shown in FIG. 8) of interest from the section 234 and clicking on the charts tab 204. In some embodiments, the signature data or the signature plots may be stored in signature files. In some embodiments, the signature data may be uploaded automatically and the signature files may be generated automatically after each machining operation.

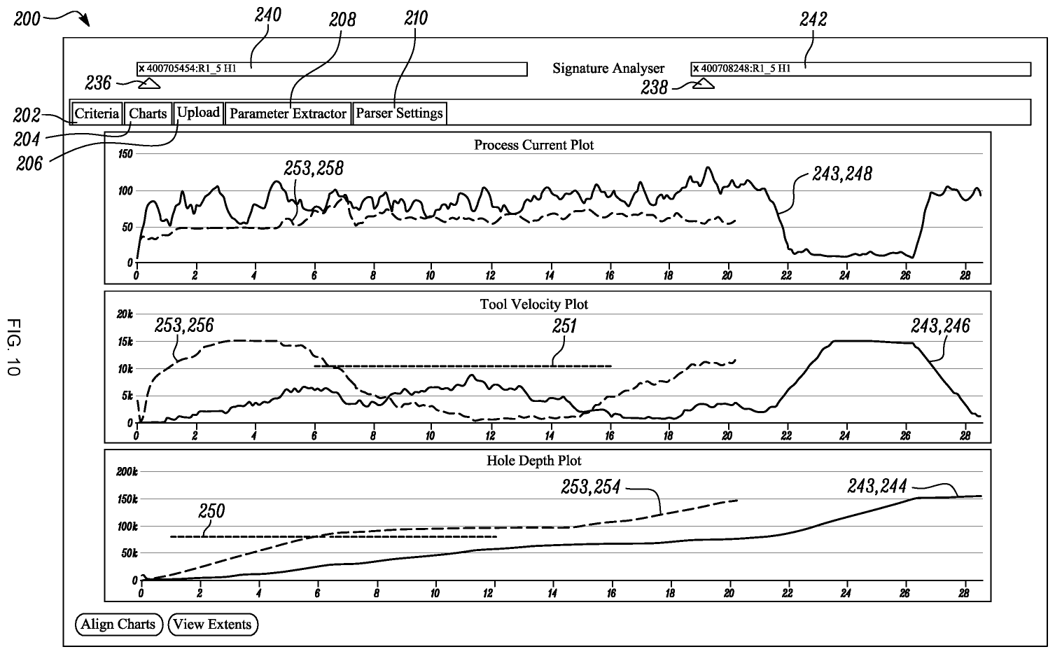

FIG. 10 is a schematic view of the charts tab 204 of the user interface 200. In some embodiments, the signature data may be generated after selecting from a row(s) of interest from the criteria tab 202 and clicking on the charts tab 204. The user interface 200 may allow signature data corresponding to multiple features 212 (shown in FIG. 8) of interest to be viewed in case there is a need to compare the signature data. This is achieved by clicking on the inputs 236, 238 (also shown in FIG. 8). The features 212 of interest may then be displayed in display boxes 240, 242 (also shown in FIG. 8).

In the illustrated embodiment of FIG. 10, the charts tab 204 shows signature plots of signature data 243 (i.e., depth data 244, tool velocity data 246, and process current data 248) corresponding to a feature R1_5 H1 (a non-conforming hole) of a workpiece (e.g., the workpiece 114) having a workpiece serial number 400705454 (shown in the display box 240). The charts tab 204 further shows signature plots corresponding to another signature data 253 in dotted lines (i.e., depth data 254, tool velocity data 256, and process current data 258) corresponding to a conforming feature R1_5 H1 of a workpiece with a workpiece serial number 400708248 (shown in the display box 242). The charts tab 204 further shows a gate 250 (e.g., the depth trigger gate) and a gate 251 (e.g., the velocity gate) common to both the signature data 243 and 253.

FIG. 10 shows that the signature plot of the depth data 244 missed the gate 250, resulting in BWI. Thus, the user interface 200 may allow comparison between the signature plots of a same feature 212 (shown in FIG. 8) of interest corresponding to various workpieces, thereby allowing determination of the one or more characteristics CH of a hole (i.e., the same feature 212) of the various workpieces of interest. In some embodiments, the user interface 200 may allow automatic selection of the master signature data from the machining programs (in order to provide comparative data), and selection and viewing of the signature data corresponding to a same feature 212 of multiple workpieces of interest within the charts tab 204, thereby enabling multiple signature plots to be compared at the same time.

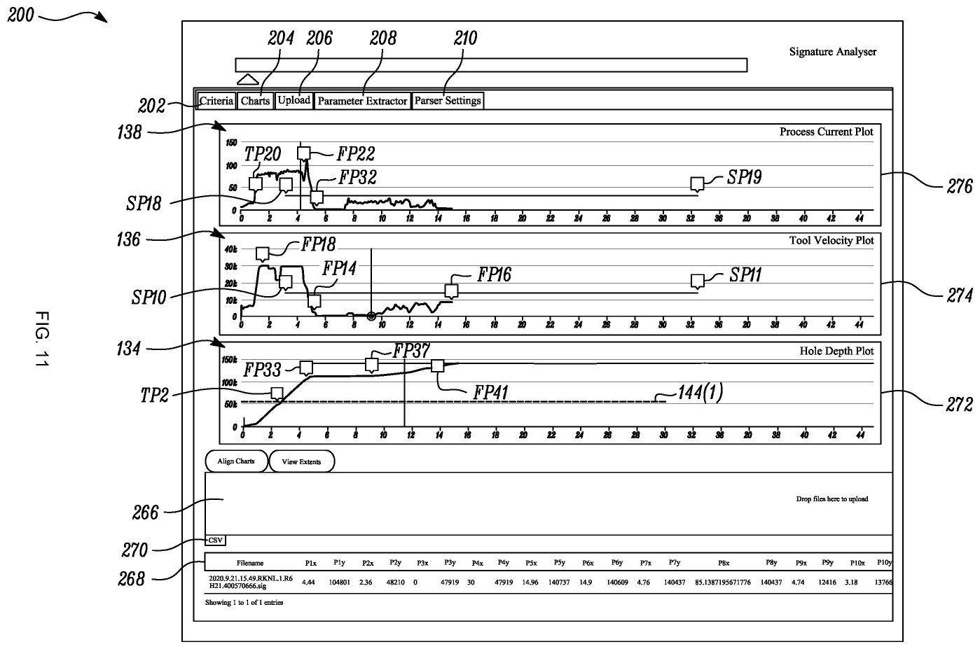

FIG. 11 is a schematic view of the parameter extractor tab 208 of the user interface 200. Referring to FIGS. 4, 5 and 11, in some embodiments, the processor 140 is further configured to output, via the user interface 200, the plurality of key points KP (i.e., the plurality of first key points FP, the plurality of second key points SP, and the plurality of third key points TP) of the signature data obtained from the drilling of the hole 112 (shown in FIG. 3). Specifically, the parameter extractor tab 208 of the user interface 200 outputs the plurality of key points KP. In some embodiments, the processor 140 may automatically determine the plurality of key points KP upon selecting or uploading the corresponding signature data.

In some embodiments, the plurality of key points KP may be determined after manually uploading the signature data, i.e., the depth data 134, the tool velocity data 136, and the process current data 138 to a search box 266 of the parameter extractor tab 208. The values of the plurality of key points KP are displayed in a display box 268 and may be downloaded to an excel spreadsheet by clicking a download button 270. The plots corresponding to the depth data 134, the tool velocity data 136, and the process current data 138 along with the plurality of key points KP are displayed in display boxes 272, 274, 276, respectively. In the illustrated embodiment of FIG. 11, only some of the plurality of key points KP are shown for the purpose of illustration.

In some embodiments, the signature plots are parsed continuously and automatically from the memory 132. Alternatively, parsing may be done manually by clicking on parser settings tab 210 and entering a part number or a workpiece serial number of interest and a time period.

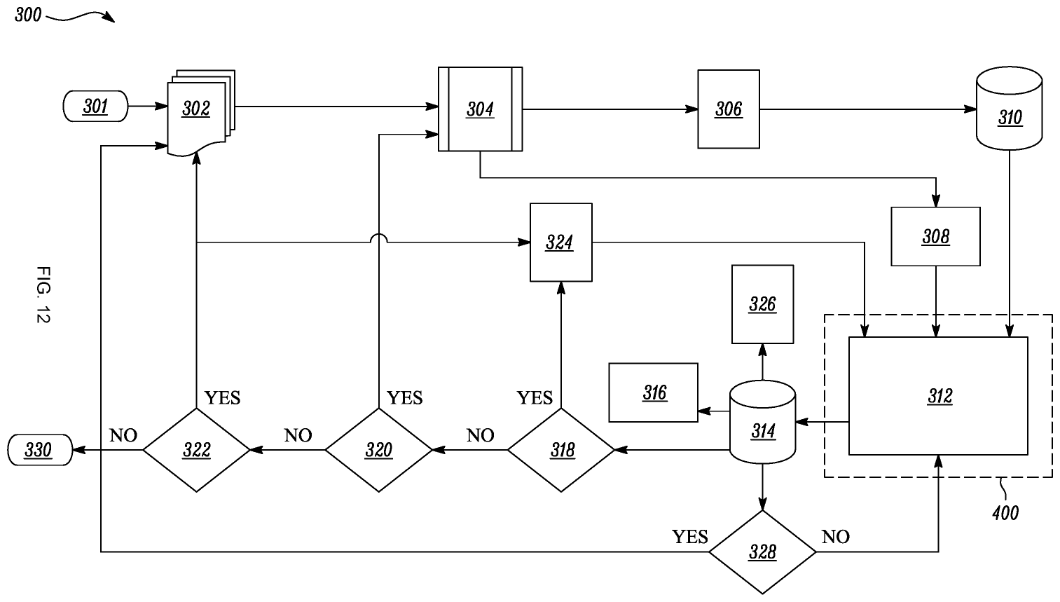

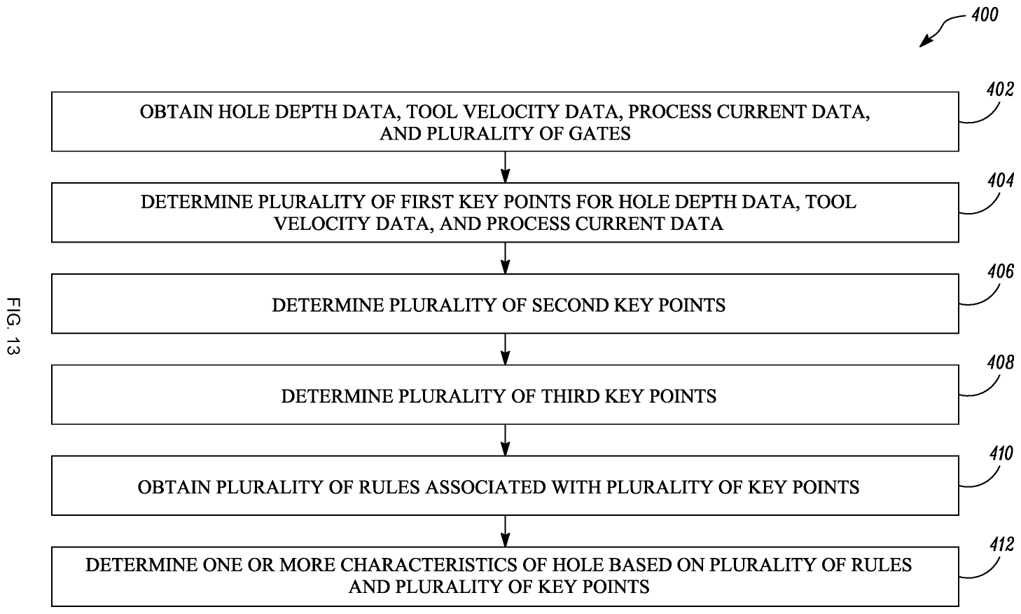

FIG. 12 is a schematic flowchart illustrating an EDM process 300. FIG. 13 is a flowchart illustrating a method 400 for determining the one or more characteristics CH of the hole 112 machined in the at least one workpiece 114 by the machining process 110. The EDM process 300 and the method 400 may be implemented using the machining process 110 shown in FIG. 3, the system 130 shown in FIG. 4, the graphs 150, 160, 170 of FIGS. 5-7, and the user interface 200 of FIGS. 8-11. In some embodiments, the at least one workpiece 114 is the aerofoil 100 (shown in FIG. 2) of the gas turbine engine 10 (shown in FIG. 1). In some embodiments, the hole 112 is the cooling hole 108 (shown in FIG. 2) of the aerofoil 100 of the gas turbine engine 10.

Referring to FIGS. 2-12, the EDM process 300 starts at block 301. At block 302, the EDM process 300 includes receiving the machining program 133. In some embodiments, the hole 112 is machined on the at least one workpiece 114 using the machining program 133. At block 304, the EDM process 300 further includes machining the hole 112 in the at least one workpiece 114. In some embodiments, the EDM process 300 may also be used to machine multiple holes 112 in the at least one workpiece 114 simultaneously or otherwise. At block 308, the EDM process 300 further includes generating process history files (or part life files) that provides traceability information for the hole 112 machined by the drilling machine 111.

At block 306, the EDM process 300 further includes generating the signature data (i.e., the depth data 134, the tool velocity data 136, the process current data 138, and the plurality of gates 144). At block 310, the EDM process 300 further includes storing the signature data together with the machining program 133 that contains the master signature data (to provide comparative data). At block 312, the method 400 of FIG. 13 starts. In some embodiments, the traceability information (i.e., the drilling machine 111 and the tool 120 used to produce the hole 112) provided by the process history files at block 308 may also be used at block 312 for further analysis.

Referring to FIGS. 2-13, the method 400 includes obtaining the depth data 134 including the variation of the depth HD of the hole 112 with respect to time T, the tool velocity data 136 including the variation of the tool velocity TV of the tool 120 performing the machining process 110 with respect to time T, the process current data 138 including the variation of the average process current PC generated during the machining process 110 with respect to time T, and the plurality of gates 144. Each of the plurality of gates 144 detects the respective phase C1-C3 in the machining process 110. Each gate 144 includes the beginning BG and the end EG with respect to time T.

At step 404, the method 400 further includes determining the plurality of first key points FP for the depth data 134, the tool velocity data 136, and the process current data 138. In some embodiments, each of the plurality of first key points FP corresponds to the respective key event in the respective depth data 134, the respective tool velocity data 136, or the respective process current data 138. At step 406, the method 400 further includes determining the plurality of second key points SP. Each of the plurality of second key points SP characterize the beginning BG or the end EG of a respective gate 144 from the plurality of gates 144.

At step 408, the method 400 further includes determining the plurality of third key points TP. Each of the plurality of third key points TP is formed by the intersection between the respective gate 144 from the plurality of gates 144 and the respective depth data 134, the tool velocity data 136, or the process current data 138. The plurality of first key points FP, the plurality of second key points SP, and the plurality of third key points TP together form the plurality of key points KP corresponding to the machining process 110.

At step 410, the method 400 further includes obtaining the plurality of rules 142(1)-142(M) associated with the plurality of key points KP. Each of the plurality of rules 142(1)-142(M) includes one of: the relationship between the respective key point KP from the plurality of key points KP and the value associated with the respective key point KP; and the relationship between the two or more respective key points KP from the plurality of key points KP. At step 412, the method 400 further includes determining the one or more characteristics CH of the hole 112 based on the plurality of rules 142(1)-142(M) and the plurality of key points KP. In some embodiments, the one or more characteristics CH include at least one of a conforming hole, a non-conforming hole, a partially blocked hole, a blocked hole, a tapered hole, and a backwall impingement. In some embodiments, the method 400 further includes changing at least one of the beginning BG and the end EG of the at least one gate 144 from the plurality of gates 144 based on the one or more characteristics CH of the hole 112.

In some embodiments, the method 400 further includes determining the one or more characteristics of the machining process 110, based on the plurality of rules 142(1)-142(M) and the plurality of key points KP. In some embodiments, the one or more characteristics of the machining process 110 include process capability and process stability.

In some embodiments, at least one rule 142 from the plurality of rules 142 includes that one third key point TP from the plurality of third key points TP does not include a null value. In some embodiments, determining the one or more characteristics CH of the hole 112 further includes determining that the hole 112 is a non-conforming hole if the one third key point TP includes a null value. In some embodiments, at least one rule 142 from the plurality of rules 142 includes the relationship between one first key point FP from the plurality of first key points FP and one second key point SP from the plurality of second key points SP. In some embodiments, determining the one or more characteristics CH of the hole 112 further includes determining that the hole 112 is a non-confirming hole if the one first key point FP and the one second key point SP do not satisfy the at least one rule 142.

In some embodiments, at least one rule 142 from the plurality of rules 142 includes the relationship between one second key point SP from the plurality of second key points SP and one third key point TP from the plurality of third key points TP. In some embodiments, determining the one or more characteristics CH of the hole 112 further includes determining that the hole 112 is a non-confirming hole if the one second key point SP and the one third key point TP do not satisfy the at least one rule 142. In some embodiments, at least one rule 142 from the plurality of rules 142 includes the relationship between one first key point FP from the plurality of first key points FP and the value associated with the one first key point FP. In some embodiments, determining the one or more characteristics CH of the hole 112 further includes determining that the hole 112 is a non-confirming hole if the one first key point FP does not satisfy the at least one rule 142.

In some embodiments, the at least one workpiece 114 includes the plurality of workpieces 114(1)-114(T). In some embodiments, the method 400 further includes selecting one rule 142 from the plurality of rules 142 including the relationship between the two or more respective key points KP. In some embodiments, the method 400 further includes obtaining the plurality of values 162(1)-162(T) of each of the two or more key points KP corresponding to the plurality of workpieces 114(1)-114(T). In some embodiments, the method 400 further includes applying the one rule 142 to the plurality of values 162(1)-162(T) corresponding to the plurality of workpieces 114(1)-114(T). In some embodiments, the method 400 further includes determining the process characteristic MC of the machining process 110 based on the application of the one rule 142.

Referring again to FIG. 12, besides using the plurality of rules 142 and the plurality of key points KP, the EDM process 300 may further include utilization of EDM drilling key process variables, such as dielectric flow rate, casting data, supply voltage, tool or electrode bore size, tool or electrode length, other EDM parameters, etc., and workpiece airflow data. Each of the plurality of workpieces 114 may have a specification for airflow, which must be kept within limits to avoid non-conformances.

For example, condition of the hole breakthrough detected by the system 130 may impact a diameter of the hole 112, and as a result, may impact the airflow. With airflow data as part of the analysis at block 312, the EDM process 300 may allow self-adjustment to the machining process 110 for producing conforming parts in terms of airflow requirements.

In some embodiments, the analysis at block 312 may further include use of techniques such as, e.g., image processing, neural network, etc., that correlates a shape of the plots of the signature data with the one or more characteristics CH of the hole 112. In some embodiments, the analysis at block 312 may further include statistical process control or statistical analysis as described above. Such an analysis may be carried out continuously and/or automatically in order to determine if the machining process 110 is stable/capable, and to identify common causes (e.g., position of the gates 144) and special causes or outliers (e.g., defective drilling machine 111 and/or the tool 120) of process instability and/or lack of capability.

At block 314, the EDM process 300 further includes storing the one or more characteristics CH of the hole 112 of the at least one workpiece 114 in the memory 146. In some embodiments, the memory 146 may also store the key points KP and the traceability information (i.e., the drilling machine 111 and the tool 120 used to produce the hole 112) provided by the process history files at block 308. At block 316, the EDM process 300 further includes outputting, via the user interface 200, the plurality of key points KP and the one or more characteristics CH of the hole 112.

At block 318, the EDM process 300 further includes automatically determining if the hole 112 is conforming based on analysis at block 312. Specifically, at block 318, “YES” refers to a case in which the hole 112 is conforming and “NO” refers to a case in which the hole 112 is non-conforming. Control moves to block 324 if the hole 112 is determined to be conforming. At block 324, the EDM process 300 further includes automatically booking the at least one workpiece 114 to the manufacturing executive system (MES) or shopfloor data management (SFDM). Data stored in the MES or the SFDM may be fed back to the analysis at block 312.

Otherwise, control moves to block 320 if the hole 112 is determined to be non-conforming. At block 320, the EDM process 300 further includes determining if the hole 112 is blocked or partially blocked (based on the analysis at block 312). Specifically, at block 320, “YES” refers to a case in which the hole 112 is blocked and “NO” refers to a case in which the hole 112 is not blocked. If the hole 112 is blocked, then the at least one workpiece 114 is automatically reworked (e.g., via the drilling machine 111 at block 304) and the reworking is recorded in the process history files at block 308. Information from the process history files may be again fed back to the analysis at block 312. After completing the rework, the at least one workpiece 114 is unloaded from the drilling machine 111.

Control moves to block 322 if the hole 112 is not blocked. At block 322, the EDM process 300 further includes determining if the hole 112 includes other predefined non-conformances (e.g., tapered holes, BWI, false starts, oversized holes, etc.). Specifically, at block 322, “YES” refers to a case in which the other predefined non-conformances are present and “NO” refers to a case in which the other predefined non-conformances are not present. If the presence of other non-conformances is detected, then the non-conformance is automatically reported to the MES or the SFDM and automatic adjustments may be carried out in the machining program 133 to eliminate the issue. The EDM process 300 may end at block 330 if the other predefined non-conformances are not present.

The system 130 may have the capability to identify issues due to special causes, i.e., outliers. At block 326, the EDM process 300 further includes reporting the outliers to stake holders (e.g., manufacturing engineers, production leaders, maintenance staff) via email and text messages so that corrective actions (e.g., repair of non-conforming machine or tool) may be undertaken.

At block 328, the EDM process 300 further includes determining process drifts (or if the machining process 110 is getting out of control) through the statistical analysis. Specifically, at block 328, “YES” refers to a case in which the process drift is determined and “NO” refers to a case in which the process drift is not present. If the process drift is determined, the EDM process 300 further includes undertaking corrective actions in order to avoid the occurrence of non-conformances. In some embodiments, the corrective actions to the machining process 110 (or the machining program 133) may be carried out automatically based on the above analysis in order to make the machining process 110 stable and capable.

In some embodiments, the corrective actions may involve any aspect of the EDM process 300, including adjustments to the drilling machine 111, the tool 120, and/or the machining program 133. For example, if the statistical analysis at block 312 finds that the machining process 110 is in risk of drifting or getting out of control due to common causes, then corrective actions are carried out automatically via fine adjustments to the machining program 133. If the process drift is not determined, information is fed back to the analysis at block 312. In some embodiments, the EDM process 300 may be a closed-loop system that may allow information from the blocks 308, 324, 328 to be fed back to the analysis at block 312.

In some embodiments, the determination of the plurality of key points KP (i.e., the plurality of first key points FP, the plurality of second key points SP, and the plurality of third key points TP) and the statistical analysis may allow quick and accurate determination of the conformances and the non-conformances. In some embodiments, the system 130 and the method 400 of the present disclosure may allow robust inspection of the hole 112 as the user interface 200 may output the gates 144 that have been missed and the associated risk of non-conformances.

Positions of the gates 144 must be set within the machining program 133 after considering process variations, such as a casting wall thickness, a tool (or electrode) batch, and a type of the drilling machine 111. However, this is usually not possible to achieve during development of a new process due to limited number of workpieces and tool batches. The system 130 and the method 400 of the present disclosure may further allow the positions of the gates 144 to be reset or reviewed after a new process is implemented, in order to capture and compensate all process variations.

In some embodiments, the one or more characteristics CH of the hole 112 may also be determined manually through the user interface 200. For example, after completion of the machining process 110, the at least one workpiece 114 is unloaded from the drilling machine 111 and water is removed from the hole 112 and the internal cavity 104 of the aerofoil 100 at an air blow station such that the hole 112 may be manually inspected. In some embodiments, the user interface 200 may aid in the manual inspection of the hole 112, thereby enhancing a robustness of the manual inspection. If the output at the user interface 200 shows that the hole 112 is conforming, then the at least one workpiece 114 is manually booked to the MES or the SFDM. If the output at the user interface 200 shows that the hole 112 is blocked, then the at least one workpiece 114 is reloaded to the drilling machine 111 for rework.

The system 130 and the method 400 of the present disclosure may allow quick access to the one or more characteristics CH of the hole 112 and the signature data allowing the operator to find a root cause of the non-conformance and to implement process changes to contain the problem. Once a production issue is raised, the workpiece serial number 220 of the at least one workpiece 114 and the features 212 affected by the issue are requested by the operator responsible for solving the issue. The signature data (i.e., the depth data 134, the tool velocity data 136, and the process current data 138) may then be analysed (automatically or manually) through the system 130 and the method 400 followed by corrective actions.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method for determining one or more characteristics of a hole machined in at least one workpiece by a machining process, the method comprising:
obtaining depth data comprising a variation of a depth of the hole with respect to time, tool velocity data comprising a variation of a tool velocity of a tool performing the machining process with respect to time, process current data comprising a variation of an average process current generated during the machining process with respect to time, and a plurality of gates, wherein each of the plurality of gates detects a respective phase in the machining process, and wherein each gate comprises a beginning and an end with respect to time;
determining a plurality of first key points for the depth data, the tool velocity data, and the process current data, wherein each of the plurality of first key points corresponds to a respective key event in the respective depth data, the respective tool velocity data, or the respective process current data;
determining a plurality of second key points, wherein each of the plurality of second key points characterize the beginning or the end of a respective gate from the plurality of gates;
determining a plurality of third key points, each of the plurality of third key points formed by an intersection between a respective gate from the plurality of gates and the respective depth data, the tool velocity data, or the process current data, wherein the plurality of first key points, the plurality of second key points, and the plurality of third key points together form a plurality of key points corresponding to the machining process;
obtaining a plurality of rules associated with the plurality of key points, wherein each of the plurality of rules comprises one of:
a relationship between a respective key point from the plurality of key points and a value associated with the respective key point; and
a relationship between two or more respective key points from the plurality of key points; and
determining one or more characteristics of the hole) based on the plurality of rules and the plurality of key points.

2. The method of claim 1, wherein at least one rule from the plurality of rules comprises that one third key point from the plurality of third key points does not comprise a null value, and wherein determining the one or more characteristics of the hole further comprises determining that the hole is non-conforming hole if the one third key point comprises a null value.

3. The method of claim 1, wherein at least one rule from the plurality of rules comprises the relationship between one first key point from the plurality of first key points and one second key point from the plurality of second key points, and wherein determining the one or more characteristics of the hole further comprises determining that the hole is a non-confirming hole if the one first key point and the one second key point do not satisfy the at least one rule.

4. The method of claim 1, wherein at least one rule from the plurality of rules comprises the relationship between one second key point from the plurality of second key points and one third key point from the plurality of third key points, and wherein determining the one or more characteristics of the hole further comprises determining that the hole is a non-confirming hole if the one second key point and the one third key point do not satisfy the at least one rule.

5. The method of claim 1, wherein at least one rule from the plurality of rules comprises the relationship between one first key point from the plurality of first key points and the value associated with the one first key point, and wherein determining the one or more characteristics of the hole further comprises determining that the hole is a non-confirming hole if the one first key point does not satisfy the at least one rule.

6. The method of claim 1, wherein the at least one workpiece comprises a plurality of workpieces, and wherein the method further comprises:
selecting one rule from the plurality of rules comprising the relationship between the two or more respective key points;
obtaining a plurality of values of each of the two or more key points corresponding to the plurality of workpieces;
applying the one rule to the plurality of values corresponding to the plurality of workpieces; and
determining a process characteristic of the machining process based on the application of the one rule.

7. The method of claim 1, further comprising changing at least one of the beginning and the end of at least one gate from the plurality of gates based on the one or more characteristics of the hole.

8. The method of claim 1, wherein the one or more characteristics of the hole comprise at least one of a conforming hole, a non-conforming hole, a partially blocked hole, a blocked hole, a tapered hole, and a backwall impingement.

9. The method of claim 1, further comprising outputting, via a user interface, the plurality of key points and the one or more characteristics of the hole.

10. The method of claim 1, wherein the machining process is an electrical discharge machining process.

11. The method of claim 1, wherein the at least one workpiece is an aerofoil of a gas turbine engine, and wherein the hole is a cooling hole of the aerofoil of the gas turbine engine.

12. A system for determining one or more characteristics of a hole machined in at least one workpiece by a machining process, the system comprising:
a memory configured to store depth data comprising a variation of a depth of the hole with respect to time, tool velocity data comprising a variation of a tool velocity of a tool performing the machining process with respect to time, process current data comprising a variation of an average process current generated during the machining process with respect to time, and a plurality of gates, wherein each of the plurality of gates detects a respective phase in the machining process, and wherein each gate comprises a beginning and an end with respect to time; and
a processor communicably coupled to the memory and configured to:
obtain the depth data, the tool velocity data, and the process current data;
determine a plurality of first key points for the depth data, the tool velocity data, and the process current data, wherein each of the plurality of first key points corresponds to a respective key event in the respective depth data, the respective tool velocity data, or the respective process current data;
determine a plurality of second key points, wherein each of the plurality of second key points characterize the beginning or the end of a respective gate from the plurality of gates;
determine a plurality of third key points, each of the plurality of third key points formed by an intersection between a respective gate from the plurality of gates and the respective depth data, the tool velocity data, or the process current data, wherein the plurality of first key points, the plurality of second key points, and the plurality of third key points together form a plurality of key points corresponding to the machining process;
obtain a plurality of rules associated with the plurality of key points, wherein each of the plurality of rules comprises one of:
a relationship between a respective key point from the plurality of key points and a value associated with the respective key point; and
a relationship between two or more respective key points from the plurality of key points; and
determine the one or more characteristics of the hole based on the plurality of rules and the plurality of key points.

13. The system of claim 12, wherein at least one rule from the plurality of rules comprises that one third key point from the plurality of third key points does not comprise a null value, and wherein the processor is further configured to determine that the hole is non-conforming hole if the one third key point comprises a null value.

14. The system of claim 12, wherein at least one rule from the plurality of rules comprises the relationship between one first key point from the plurality of first key points and one second key point from the plurality of second key points, and wherein the processor is further configured to determine that the hole is a non-confirming hole if the one first key point and the one second key point do not satisfy the at least one rule.

15. The system of claim 12, wherein at least one rule from the plurality of rules comprises the relationship between one second key point from the plurality of second key points and one third key point from the plurality of third key points, and wherein the processor is further configured to determine that the hole is a non-confirming hole if the one second key point and the one third key point do not satisfy the at least one rule.

16. The system of claim 12, wherein at least one rule from the plurality of rules comprises the relationship between one first key point from the plurality of first key points and the value associated with the one first key point, and wherein the processor is further configured to determine that the hole is a non-confirming hole if the one first key point does not satisfy the at least one rule.

17. The system of claim 12, wherein the at least one workpiece comprises a plurality of workpieces, and wherein the processor is further configured to:
select one rule from the plurality of rules comprising the relationship between the two or more respective key points;
obtain a plurality of values of each of the two or more key points corresponding to the plurality of workpieces;
apply the one rule to the plurality of values corresponding to the plurality of workpieces; and
determine a process characteristic of the machining process based on the application of the one rule.

18. The system of claim 12, wherein the one or more characteristics of the hole comprise at least one of a conforming hole, a non-conforming hole, a partially blocked hole, a blocked hole, a tapered hole, and a backwall impingement.

19. The system of claim 12, further comprising a user interface communicably coupled to the processor, wherein the processor is further configured to output, via the user interface, the plurality of key points and the one or more characteristics of the hole.

20. The system of claim 12, wherein the tool is an electrical discharge machining tool.
